(19) United States
(12) Patent Application Publication
(10) Pub. No.: US 2026/0131742 A1
(43) Pub. Date: May 14, 2026

(54) RACKED MODULAR BAY AND SWING-ARM VEHICLE HITCH PLATFORM

(71) Applicant: MS2 HOLDINGS, LLC, HOWELL, MI (US)

(72) Inventors: MORGAN RENE SMITH, HOWELL, MI (US); MATTHEW SMITH, HOWELL, MI (US)

(73) Assignee: MS2 HOLDINGS, LLC, HOWELL, MI (US)

(21) Appl. No.: 19/389,429

(22) Filed: Nov. 14, 2025

Related U.S. Application Data
(60) Provisional application No. 63/720,247, filed on Nov. 14, 2024.

(51) Int. Cl. B60R 9/06; A47J 37/07

(52) U.S. Cl. CPC B60R 9/06; A47J 2037/0777

(57) ABSTRACT

A racked modular system includes a rack frame defining a bay and a module that is received in the bay and removably mounted to the rack frame at a seated position. A locating interface constrains at least pitch and yaw at the seated position, and a quick-release latch with an over-center cam draws the module into the seated position. A backplane at the rear of the bay provides a blind-mate connector aligned with a corresponding connector of the module. Embodiments include floating mounts, vibration isolation, airflow shrouds, safety interlocks, and latch sensors. A vehicle cargo platform embodiment includes a pivot mast, a swing-arm, perforated trays with side rails, a ground-contacting stabilizer post configured to reduce hinge loading under payload, stops that define deployed positions, a travel latch, and an accessory hole matrix. Methods of installation, servicing, loading, and stabilizing the platform are also disclosed.

### CROSS REFERENCE TO RELATED APPLICATIONS

This application claims the benefit of U.S. Provisional Patent Application No. 63/720,247, filed Nov. 14, 2024, titled “Modular Hitch Rack System,” the entirety of which is incorporated by reference.

### FIELD OF THE INVENTION

This disclosure relates to modular rack systems and vehicle-mounted hitch rack platforms for transporting, storing, and supporting equipment and accessories. In various embodiments, a base structure engages a vehicle hitch receiver and supports interchangeable modules that can swing or rotate between stowed and deployed positions to maintain access to the rear of the vehicle while carrying cargo or task-specific components.

### BACKGROUND

Racked systems and vehicle-mounted hitch platforms are used to transport, store, and support equipment and accessories in consumer, commercial, and industrial settings. Conventional solutions include fixed cargo carriers, swing-out frames, and task-specific racks. While these products can move payloads, they often introduce practical and serviceability challenges.

Many existing hitch-mounted platforms obstruct access to rear vehicle areas when loaded, or they provide only a single open position without positive stops for intermediate use. In some cases, latching hardware is not optimized for repeated field use, which can complicate securing the platform for travel. Load retention can also be limited when tie-down patterns are sparse or not aligned with common cargo shapes, making it harder to route straps reliably.

Similarly, modular rack and bay systems for equipment often depend on tool-based fasteners and loose alignment tolerances that complicate installation and removal. Blind-mate electrical or data connections can be difficult to align repeatably, and cable management add-ons may increase bulk or interfere with servicing. Vibration transmission and airflow constraints can degrade the performance or longevity of equipment mounted in these racks.

Therefore, there remains a need for systems that: (i) provide stable, repeatable alignment during insertion and removal, (ii) allow selective movement between closed, intermediate, and fully open positions with positive retention, (iii) support secure load restraint using versatile tie-down matrices or equivalent features, and (iv) facilitate quick, tool-limited servicing while accommodating power and data interfacing where required. Such systems should maintain rear-of-vehicle access, improve safety and usability in the field, and reduce time and effort associated with installation, reconfiguration, and maintenance.

### SUMMARY OF THE INVENTION

The following summary is provided to introduce, in a simplified form, selected concepts that are further described in the detailed description below. This summary is not intended to identify all key or essential features of the claimed subject matter, nor is it intended to be used as an aid in determining the scope of the claimed subject matter.

In one aspect, a racked modular system includes a rack frame with opposing guide rails that define a bay, a module sized to slide along the rails, a locating interface that constrains at least pitch and yaw at a seated position, and a quick-release latch arranged to draw the module into the seated position without tools. A backplane at the rear of the bay provides a blind-mate electrical connector aligned to couple with a corresponding connector on the module as the module seats. Optional features include a floating mounting arrangement for the connector to accommodate tolerance variation, vibration isolation between the module and the rails, an airflow shroud, a safety interlock that interrupts power when unlatched, and a latch state sensor for telemetry or control.

In another aspect, a module for installation in such a system includes a chassis, an alignment interface that cooperates with a complementary interface of the rack frame to maintain repeatable positioning, a connector configured for blind-mating at the seated position, and a quick-release latch with an over-center action. The module can include an ejection lever to initiate extraction and may carry electronics or mechanical components that benefit from the repeatable alignment and serviceability provided by the rack.

In a further aspect, a vehicle cargo platform assembly includes a pivot mast configured for attachment to a vehicle, a swing-arm coupled to the mast for movement between a closed position and one or more deployed positions, and first and second trays carried by the swing-arm. Each tray can include a perforated deck and side rails that define a perimeter guard. The assembly can include a latch to secure the swing-arm for travel, position stops that define half-open and fully open states, an accessory hole matrix to route tie-downs or mount accessories, and a stabilizer post that contacts the ground when deployed. The stabilizer post is configured to transfer at least a portion of the payload-induced load to the ground and to reduce bending moments at the hinge region of the swing-arm. As a result, the assembly can support higher payloads at a given swing-arm length than comparable hitch-mounted platforms that lack a deployed stabilizer. Cross members, gussets, and removable hinge hardware can be used to facilitate strength, service, and modularity.

In embodiments, a racked modular system according to the present disclosure may include a rack frame including opposing guide rails that define a bay, a module sized to slide along the guide rails into the bay, a locating interface between the module and the rack frame configured to constrain at least pitch and yaw when the module is seated, a quick-release latch coupled to the module and arranged to draw the module into a seated position against the rack frame, and a backplane at a rear of the bay including a blind-mate electrical connector aligned to mate with a corresponding connector of the module as the module reaches the seated position.

In embodiments, the system according to the present disclosure may include a locating interface comprises a keyed tongue on the module and a complementary receptacle on the rack frame.

In embodiments, the system according to the present disclosure may include a locating interface comprises a tapered pin and a complementary tapered bore.

In embodiments, the system according to the present disclosure may include a quick-release latch includes an over-center cam configured to apply a seating force without tools.

In embodiments, the system according to the present disclosure may include an ejection lever coupled to the quick-release latch to initiate module extraction when the latch is released.

In embodiments, the system according to the present disclosure may include a backplane includes a floating mount for the blind-mate electrical connector to accommodate tolerance variation.

In embodiments, the system according to the present disclosure may include a latch sensor configured to detect whether the quick-release latch is in a latched state.

In embodiments, the system according to the present disclosure may include a module configured for installation in a racked modular system having a rack frame and guide rails, the module including a chassis sized to slide along the guide rails, an alignment interface configured to cooperate with a complementary interface of the rack frame to constrain at least pitch and yaw at a seated position, a connector mounted to the chassis and configured for blind-mating with a backplane connector at the seated position, and a quick-release latch having an over-center cam to draw the module to the seated position relative to the rack frame.

In embodiments, the system according to the present disclosure may include an alignment interface comprises a locating tongue configured to engage a complementary receptacle of the rack frame.

In embodiments, the system according to the present disclosure may include a vibration isolation mount positioned between the chassis and the guide rails.

In embodiments, the system according to the present disclosure may include a quick-release latch with an ejection lever configured to apply an initial extraction force when the module is unlatched.

In embodiments, the system according to the present disclosure may include a connector is mounted to float within limited travel to accommodate tolerance variation during blind-mating.

In embodiments, the system according to the present disclosure may include an airflow shroud configured to direct cooling air across the chassis when the module is seated.

In embodiments, the system according to the present disclosure may include a cargo platform assembly including a pivot mast configured for attachment to a vehicle, a swing-arm coupled to the pivot mast for movement between a closed position adjacent the vehicle and at least one deployed position, first and second trays carried by the swing-arm, each tray including a perforated deck and side rails that define a perimeter guard, a latch configured to retain the swing-arm in the closed position, and an accessory hole matrix arranged to receive tie-downs or modular brackets.

In embodiments, the system according to the present disclosure may include deployed positions including a half-open position and a fully-open position defined by stops at the pivot mast.

In embodiments, the system according to the present disclosure may include a stabilizer post configured to contact the ground when the swing-arm is deployed to reduce deflection under load.

In embodiments, the system according to the present disclosure may include a stabilizer post is telescoping between a stowed length and an extended length and includes a locking collar or detent mechanism configured to hold the stabilizer post at selected heights.

In embodiments, the system according to the present disclosure may include a stabilizer post includes a ground-engaging foot with a high-friction pad configured to increase resistance to sliding and to transfer at least a portion of a payload-induced load from the swing-arm to the ground.

In embodiments, the system according to the present disclosure may include a stabilizer post comprises a jack mechanism selected from a threaded jack screw, a cam jack, and a ratcheting jack, configured to apply an upward pre-load to the swing-arm to counteract deflection induced by cargo weight.

In embodiments, the system according to the present disclosure may include a swing-arm having a hinge with a removable pin and the pivot mast is coupled to a hitch receiver via a receiver insert, and the assembly further includes at least one cross member positioned under the trays.

In embodiments, the system according to the present disclosure may include a rack frame defining a bay, a module sized to be received in the bay and removably mounted to the rack frame at a seated position, a locating interface between the module and the rack frame configured to constrain at least pitch and yaw when the module is seated, a quick-release latch coupled to the module and arranged to draw the module into the seated position against the rack frame, and a backplane at a rear of the bay including a blind-mate electrical connector aligned to mate with a corresponding connector of the module as the module reaches the seated position.

In embodiments, the system according to the present disclosure may include a rack frame that includes opposing guide rails that define the bay and the module is configured to slide along the guide rails into the bay.

In embodiments, the system according to the present disclosure may include a rack frame that defines a bay, the module including a chassis sized to be received in the bay, an alignment interface configured to cooperate with a complementary interface of the rack frame to constrain at least pitch and yaw at a seated position, a connector mounted to the chassis and configured for blind-mating with a backplane connector at the seated position, and a quick-release latch having an over-center cam to draw the module to the seated position relative to the rack frame.

In embodiments, the system according to the present disclosure may include a chassis that is configured to slide along guide rails of the rack frame into the bay.

In embodiments, the system according to the present disclosure may include a swing-arm extends across the pivot mast such that the first tray is located on a first side of the pivot mast and the second tray is located on an opposite side of the pivot mast so that payloads supported by the trays are distributed on opposite sides of the pivot mast.

In some embodiments the blind-mate connector supplies electrical power, and in other embodiments it may additionally or alternatively carry data signals.

In some embodiments the system may include a pivot mast is coupled to a hitch receiver via a receiver insert and a pivot axis of the swing-arm is offset laterally relative to the receiver insert such that in the closed position the trays are positioned closer together to reduce an overall width of the assembly and in a deployed position the trays are spaced farther apart to increase usable width and clearance relative to a rear portion of the vehicle

Methods are also provided for installing and servicing modules in the rack system and for deploying, loading, securing, and stowing cargo on the vehicle platform. Features described for one aspect can be combined with features of another aspect where compatible, and dimensions or materials mentioned in example embodiments are illustrative and not limiting.

The foregoing summary is intended to provide a brief overview of certain embodiments to facilitate a basic understanding of some aspects of the invention. It is not intended to provide an exhaustive description of every embodiment or every feature of the invention. The details of these and other embodiments are set forth in the detailed description and drawings, and the scope of the invention is defined solely by the appended claims.

Thus, references in this summary to particular structures, arrangements, or combinations are provided by way of example and are not intended to limit the claimed subject matter to the specific embodiments described herein.

### BRIEF DESCRIPTION OF THE DRAWINGS

The accompanying drawings, which are incorporated in and constitute a part of this specification, illustrate example embodiments of the disclosure and, together with the description, serve to explain principles of the disclosed systems and methods. The drawings are not necessarily to scale, and certain features may be exaggerated or simplified for clarity of illustration. Like reference numerals in the different figures designate corresponding elements throughout the views, and repeated description of such elements may be omitted where appropriate for brevity.

The disclosure is described in greater detail by way of the example only and with referenced to the attached drawings, in which:

FIGS. 1-4 are perspective views one embodiment of the present disclosure;

FIG. 5 is a perspective view of another embodiment of the present disclosure;

FIGS. 6-13 are perspective views of another embodiment of the present disclosure;

FIGS. 14-18 are perspective views of another embodiment of the present disclosure;

FIGS. 19-20 are perspective views of another embodiment of the present disclosure;

FIGS. 21-29 are perspective views of another embodiment of the present disclosure;

FIGS. 30-31 are perspectives view of another embodiment of the present disclosure;

FIGS. 32-33 are perspective views of another embodiment of the present disclosure;

FIGS. 34-38 are perspective views of another embodiment of the present disclosure;

FIGS. 39-43 are perspective views of another embodiment of the present disclosure;

FIGS. 44-62 are various views of the embodiment of the present disclosure;

FIGS. 63-66 are perspective views of components of an embodiment of the present disclosure.

FIGS. 67-68 are perspective views of an embodiment of the present disclosure.

FIG. 69 is a perspective view of components of an embodiment of the present disclosure.

FIGS. 70-73 are perspective views of an embodiment of the present disclosure.

FIG. 74 is a perspective view of components of an embodiment of the present disclosure.

FIGS. 75-79 are perspective views of an embodiment of the present disclosure.

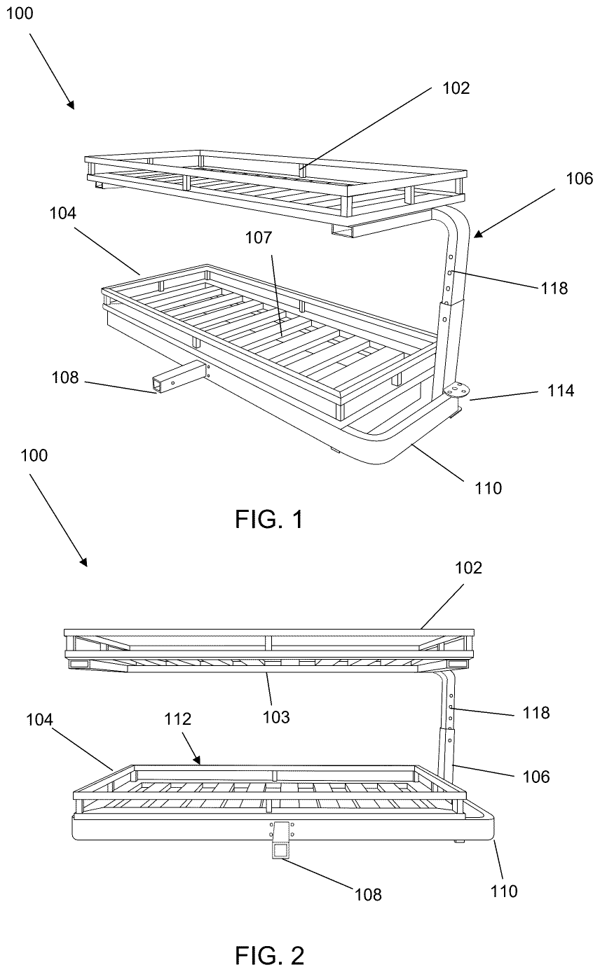

The drawings are intended to illustrate representative configurations and relationships between components of the disclosed systems. Not every possible feature or embodiment is shown in the drawings, and the absence of a particular feature from a given figure is not an indication that the feature is excluded from the scope of the claimed invention.

Additional structural and functional details of the embodiments illustrated in the drawings are set forth in the following detailed description.

### DETAILED DESCRIPTION

The following detailed description is directed to certain illustrative embodiments of racked modular systems and vehicle hitch rack platforms. These embodiments are described in sufficient detail to enable a person of ordinary skill in the art to make and use the disclosed subject matter. It is to be understood that the embodiments are examples only and that other embodiments may be utilized and structural, electrical, and logical changes may be made without departing from the scope of the claimed subject matter.

Definitions and interpretation. Unless stated otherwise, terms such as “comprising,” “including,” “having,” and “containing” are intended to be open-ended and non-exclusive. The singular forms “a,” “an,” and “the” include plural referents unless the context clearly dictates otherwise. Ranges include all endpoints and subranges. Where “about” is used with a numeric value, it includes ±10% of that value unless a different tolerance is expressly stated.

Orientation and reference numerals. Directional terms such as front, rear, left, right, upper, and lower are used for convenience of description and do not limit the orientation of an apparatus in use. Reference numerals are provided for clarity and are not intended to limit the scope of the claims to the particular structures identified.

Coupling and interaction. The terms “coupled,” “connected,” “engaged,” and “mounted” include direct and indirect connections, and can be mechanical, magnetic, adhesive, welded, riveted, bolted, pinned, or via one or more intermediate components. Elements described as “integral” may alternatively be multi-piece assemblies, and elements described as multi-piece may be formed integrally as a single piece.

Options and substitutions. Features described in connection with any embodiment may be combined with features of any other embodiment where structurally compatible. Optional features may be omitted unless explicitly required by a given claim. References to examples or embodiments are non-limiting.

Materials and finishes. Structural members may be formed from steel (e.g., low-alloy, stainless), aluminum alloys, titanium, magnesium, fiber-reinforced composites, engineering polymers (e.g., nylon, acetal, polycarbonate, PBT), or combinations thereof. Surface treatments can include powder coat, paint, anodize, e-coat, plating, passivation, or conversion coatings suited to outdoor and corrosive environments.

Manufacturing. Components may be made by stamping, laser cutting, water-jet cutting, press braking, machining, casting, forging, extrusion, additive manufacturing, or any combination. Joints may be welded (MIG, TIG, spot), brazed, bonded, or mechanically fastened with threaded or non-threaded hardware. Tolerances may be selected to achieve repeatable alignment in field conditions.

Operating environment. Systems may be used in temperatures from about −40° C. to about 85° C., under dust, moisture, salt-spray, and UV exposure. Drainage apertures, sealed connectors, and UV-stable polymers may be employed for longevity.

The modular hitch rack system of the present disclosure is configured to be used with a variety of vehicles, including but not limited to pickup trucks, SUVs, sedans, and coupes. Any vehicle equipped with a trailer hitch may use the modular hitch rack system of the present disclosure.

In some embodiments the bay is defined by brackets, flanges, posts, or a perimeter frame that receives the module without requiring sliding motion along guide rails. For example, a module may be lowered vertically into the bay, pivoted into the bay on a hinge, or offered up in a straight-line approach from the rear or side, and then drawn into a seated position by the quick-release latch. The bay geometry and locating interface cooperate to constrain at least pitch and yaw at the seated position regardless of whether the module is slid along rails or placed directly into the bay.

The locating interface may be positioned so that it engages primarily at or near the seated position. Thus, even when a module is placed into the bay without sliding along rails, the locating interface still provides repeatable constraint of pitch and yaw once the quick-release latch draws the module into contact with the rack frame.

In certain embodiments, the quick-release latch not only retains the module in the seated position but also generates a seating motion that pulls the module into firm engagement with the locating interface and backplane. For example, an over-center cam can convert a small handle motion into both axial draw-in and clamping, allowing a user to loosely place the module in the bay and then actuate the latch to complete alignment and electrical mating.

The modular hitch rack system of the present disclosure is configured to engage with a vehicle's trailer hitch receiver. In some embodiments, the modular hitch rack system may directly engage with the vehicle's trailer hitch receiver or an adapter may be used. The adapter may change the receiver size in order to engage the modular hitch rack system.

The modular hitch rack system is configured for ease of use for a plurality of activities. The modular hitch rack system is configured to allow one or more storage racks of the modular hitch rack system (or other components, such as, but not limited to, a BBQ) to rotate or swing from a stowed position to an open position. The open position allows a user to access the rear of the vehicle. The rear of the vehicle may include a variety of access points. These access points may include a tailgate, one or more cargo doors, a cargo hatch, and/or a spare tire (whether mounted on the rear or bottom (underneath) of the vehicle). In some applications, such as for use with typically older vehicles with rear-access fueling, the modular hitch rack system may allow the user to swing the modular hitch rack system to the open position to allow access to the rear-mounted fueling port of the vehicle. The modular hitch rack system as configured allows a user to access the rear portion of the vehicle without the need to unload the modular hitch rack system.

A variety of components may be used with the modular hitch rack system. It should be understood that the embodiments described herein are exemplary and not limiting.

One component of the modular hitch rack system that may be used is the storage rack component. The storage rack component may be configured in a plurality of sizes to receive various shaped cargo. In some embodiments, the storage rack may be configured with a solid floor and solid sides in the form of a bin or container. In this embodiment, the solid floor and solid sides of the storage rack container retain a plurality of loose components and/or liquids that may be present with the cargo. This configuration may be useful when the user wishes to retain all of the loaded cargo and/or prevent the cargo from exiting the container. For example, and without limitation, the cargo may be firewood. It is anticipated that the container may include a locking (or latching) cover or lid to completely enclose the container storage rack. In other embodiments, the storage rack component may be configured with a plurality of slats such that air may pass through the storage rack component. This may be beneficial for several reasons. Firstly, the items carried in the storage rack may leak, so the openings between the slats may allow for liquid to drip through unto the ground. Secondly, the slats may save weight when compared to a solid wall storage rack component. Finally, the slats may provide additional strength to carry heavy cargo, such as a fully loaded cooler or ice chest.

Another component of the modular hitch rack system that may be used is a grilling station (or BBQ). The grilling station component may include a BBQ grill that may use charcoal, wood, propane, or another fuel source to produce heat. The grilling station may include a table portion for storing food or other supplies to be used while using the grilling station component of the modular hitch rack system. The grilling station component may include a lid that may be securable (via a lock or latch, for example) to prevent the lid opening while the vehicle carrying the modular hitch rack system including the grilling station component is in motion or is parked, to prevent theft or vandalism. The grilling component may include a table or workspace as well as one or more cupholders, in certain embodiments.

Another component of the modular hitch rack system that may be used is a food prep station/table. The food prep station/table may be used in conjunction with the grilling station component of the modular hitch rack system or separately. For example, the modular hitch rack system in one embodiment may include a grilling station component and a food prep station component.

In this configuration, a user may use the food prep station component to store food to be cooked on the grilling station component as well as to store food already cooked using the grilling station component. Alternatively, the food prep station component may be used to serve food or other food-related items, or as a place to keep belongings off of the ground. By having the grilling station component and the food prep station component, in one embodiment, on opposite sides of the modular hitch rack system (and also on opposite sides of the vehicle trailer hitch), a user may be able to access the interior of the vehicle equipped with the modular hitch rack system of the present disclosure. This is advantageous as it allows the user to retrieve items from the vehicle without having to remove or move the grilling station component or the food prep station component as each may be rotated or moved clear of the vehicle. Once those two components are clear of the vehicle, the user may open the hatch, tailgate, cargo door, trunk or other portion of the vehicle to access cargo, or allow the user or others to enter or exit the vehicle.

In another configuration, the food prep station component may be located under the grilling station component of the modular hitch rack system. In this configuration, the food prep station component is located conveniently close to the grilling station component to allow a user to quickly and easily move food to be cooked on the grilling station component or to remove cooked food from the grilling station component to the food prep station component. Additionally, items related to the cooking of food (seasoning, sauces, cooking tools, etc.) may also be conveniently located on or about the food prep station component as well as the grilling station component. For example, and without limitation, it is contemplated that one or both of the grilling station component and the food prep station component may include provisions for storing food-related items (tools, condiments, towels, etc.).

Another component of the modular hitch rack system is the bike rack component. The bike rack component may attach (like the other components of the modular hitch rack system) to the modular hitch rack system and allow the bike rack to move, pivot, or otherwise rotate out of the way of the vehicle equipped with the modular hitch rack system. The bike rack may be configured to carry one or more bicycles of the same or differing sizes. By using the term “bicycle” or “bike” it is intended to represent a plurality of one- or two-wheeled vehicles at the minimum, including traditional pedal bikes, electronic or “e-bikes,” scooters, and other related transport vehicles. One or more bikes may be secured to the bike rack component using included storage and securing devices and/or use supplemental devices (padlock, chain, etc.). As the bike rack component (and the other components described herein) of the modular hitch rack system may be securedly attached to the modular hitch rack system, additional security devices of the bike rack components and other components of the modular hitch rack system may be included and/or contemplated. The bike rack component allows the user to move the bike rack (with or without one or more bikes) from a stowed position adjacent to the vehicle to an open or partially open position away from the vehicle to access the cargo area located at the rear of the vehicle, adjacent to the trailer hitch.

Another component of the modular hitch rack system is the wild game processing component. The wild game processing component may be configured to allow a user (hunter) to process wild game after a hunt. The wild game processing component may include elements such as a solid table, slotted rack, or other suitable components and include provisions for storing processing-related gear. The wild game processing component may include a winch or crane used to hold wild game. The winch or crane may be used to allow for the processing of wild game and/or to hold it securely for transport. A rack component that may be located beneath the winch/crane may also allow for wild game to be transported without being in contact with the vehicle equipped with the modular hitch rack system. This may be desirable to prevent damage to the vehicle or fluid or other parts of the wild game from coming into contact with the vehicle that may also result in damage or additional time to clean. The winch/crane may also be used to load or unload wild game (or other items) from within the vehicle. It is contemplated that one or more versions of the wild game processing component may be developed for varieties of wild game and the demands that each type of wild game has with regards to processing.

Another component of the modular hitch rack system is the fish/fish cleaning component. The fishing component may be configured to allow an angler a place to clean (gut, prep) fish, prepare or fix lures, maintain fishing equipment, and/or hold a variety of fishing-related gear. In one embodiment, the fish component may include devices to hold fishing rods, a vise for working on fishing lures, a cutting board for processing fish, as well as devices to hold fishing nets, towels, etc. It is contemplated that one or more versions of the fishing component may be developed for varieties of fish and the demands that each type of fish has with regards to fishing and fish cleaning.

Another component of the modular hitch rack system is the construction/work component. The construction component may be configured with a plurality of elements to assist a user in performing construction work. The construction component may include a plurality of elements to assist the user in construction work. For example, and without limitation, the construction component may include a built-in measuring device, a vice and/or clamps for holding workpieces, a plurality of tool holders for tools such as hammers, screwdrivers, power tools, etc. The construction/work component may also include a built-in measuring device, a vice, or a clip for securing a tape measure. The construction component may also include power connections to charge and/or power devices used in construction work. Power may include electrical power that may be sourced from within the construction component, the vehicle equipped with the construction component of the modular hitch rack system, or an external power source, such as a building, generator, backup power supply, or a nearby structure. The winch/crane as shown as part of the wild game processing component may also be used as or with the construction/work component.

Another component of the modular hitch rack system is the canopy/umbrella component of the modular hitch rack system. The canopy component may be configured with a canopy, umbrella, tent, or other shelter-type structure configured to engage the modular hitch rack system. The canopy component of the modular hitch rack system offers users a movable and removable temporary shelter that may be located at or near the rear of the vehicle equipped with the modular hitch rack system. The canopy component may include a retractable canopy or other shelter to provide users with protection from the elements—sun, rain, etc. while they are near the rear of the vehicle equipped with the canopy component of the modular hitch rack system. In some embodiments, more than one canopy component may be used with the modular hitch rack system (as with the other components described herein). In this way, a pair (or more) of canopy components may be used with the modular hitch rack system to provide shelter and/or relief from the elements in the area of the vehicle equipped with the modular hitch rack system. In embodiments, the canopy component may be used to provide shelter for additional components of the modular hitch rack system, including but not limited to, the grill component, the storage rack component (such as storing a portable cooler), and the TV/video component.

Another component of the modular hitch rack system is the seating component of the modular hitch rack system. The seating component may be configured in a plurality of seating arrangements, including but not limited to a single seat, multiple seats, a bench seat, or a seat with an included table (e.g., a picnic table). The seating component allows users to sit at or near the vehicle equipped with the modular hitch rack system. For example, the seating component may allow users to sit directly behind the vehicle or off to the side of the vehicle. The users may choose to sit facing the vehicle, facing away from the vehicle, or any position in between. Users may also use the seating component of the modular hitch rack system to participate in other activities, such as, but not limited to, eating and drinking, watching a sporting event, watching a movie or other video entertainment, playing a game, fishing, hunting, or any other number of work or leisure activities. As with the other components of the modular hitch rack system, the seating component may be used with other components of the modular hitch rack system, such as the canopy component or the grilling or food prep component.

Another component of the modular hitch rack system is the TV/video component of the modular hitch rack system. The TV/video component may be configured to hold a TV display or a movie screen, or both. The TV/video component may be moved through the range of motion of the components of the modular hitch rack system, which include adjacent to the vehicle trailer hitch, to a plurality of positions about the rotation axis of the trailer hitch and/or the modular hitch rack system. In this way, users may deploy the TV/video component of the modular hitch rack system and then move the TV/video component to a position that is most suitable to the particular location. Users may then play a video or a video game on the TV/video display or movie screen. The TV/video component may include power connections to operate the video devices. The power connections may include, as described herein, onboard power of the modular hitch rack system, the vehicle equipped with the modular hitch rack system, or an external power supply.

The modular hitch rack system is configurable with adjustable height for multiple components. For example, two storage rack components may be deployed on the modular hitch rack system such that the first storage rack component is located above the second storage rack component. In another example, a grilling component may be deployed above a storage rack component or above a food prep station component. This configuration, among others contemplated by this disclosure, enables maximum use of the available space provided by the modular hitch rack system.

Each component of the modular hitch rack system may be configured to attach to the base structure of the modular hitch rack system. The base structure of the modular hitch rack system is the portion that directly engages the vehicle trailer hitch. When so attached, the components may be moved independently or in unison, depending on the configuration of each component and/or whether or not the components are physically connected. The movement of each component may be through at least a wide arc centered upon the base structure, but other compound movements are contemplated whereby additional movements are possible.

The modular hitch rack system may be configured with a latching mechanism or device that restrains the modular hitch rack system and its components in a closed position. Similarly, the modular hitch rack system latching mechanism may include restraints to keep the modular hitch rack system and its components in a variety of open positions—from full open to a range of positions between fully open and closed. In this way, the modular hitch rack system and its components may be prevented from unintended movement through user interaction, or by other forces, such as the wind or gravity.

It should be noted that the components of the modular hitch rack system may be locked in the stored position for transportation while mounted to the vehicle via its trailer hitch. Locking may be accomplished by a mechanical device, and may include a keyed lock, a combination lock, or other secure locking device. While some embodiments may be used and removed prior to the movement of the vehicle, it is contemplated that the components of the modular hitch rack system may remain attached (and locked) to the vehicle trailer hitch via the base structure. This configuration allows the user to maximize cargo capacity in the interior of the vehicle while storing the components of the modular hitch rack system (and other items that may be carried in the components) on the exterior of the vehicle via the modular hitch rack system.

Rack frame and bays. In some embodiments, a rack frame includes opposing guide rails that define a bay sized to receive an interchangeable module. The rails can be linear, dovetail, T-slot, round-rod, or keyed profiles that constrain motion along an insertion axis and cooperate with locating features to constrain pitch, roll, and yaw at a seated position.

Locating interface variants. The locating interface may include a tongue-and-receptacle, tapered pin and bore, spherical seat, cam-follower, wedge, or kinematic three-point interface (e.g., vee-groove, flat, cone) to achieve repeatable six-degree-of-freedom constraint. Interfaces may be spring-preloaded, elastomerically isolated, or compliant to absorb tolerance stack-up.

Quick-release latch options. The quick-release latch may include over-center cams, quarter-turn fasteners, eccentric clamps, lever-actuated toggles, rotary latches, draw latches, or cam-locks to apply a seating force without tools. In some versions an ejection mechanism (e.g., spring, gas strut, or cam-ramp) provides initial extraction force when released.

Blind-mate interconnects. A backplane at the rear of the bay can provide power and/or data via blind-mate connectors, which can include blade, pogo-pin, leaf-spring, wedge, Anderson-style, multipole circular, or edge-card contacts. To accommodate misalignment, the connector may float translationally and/or angularly on a compliant mount (e.g., grommets, flexures, slots), and may include chamfers or funnels for lead-in.

Power and data. Power distribution can support low-voltage DC (e.g., 5-60 V) and may include fusing, current limiting, surge protection, reverse-polarity protection, and identification (e.g., resistor ID, EEPROM). Data interfaces can include CAN, LIN, USB, RS-485, Ethernet, or wireless interfaces (e.g., BLE, Wi-Fi) for module identification and telemetry.

Sensing and safety. A latch sensor may be a limit switch, Hall sensor, inductive sensor, optical interrupter, strain or load cell, or other transducer providing a latched/unlatched state and optional seating force read-out. A safety interlock can inhibit power to the backplane unless the module is seated and latched.

Thermal and airflow features. Optional airflow shrouds, baffles, or heat-sinks may be provided. Fans may be module-mounted or frame-mounted. Thermal interface materials can couple heat sources to chassis surfaces.

Non-vehicle implementations. In some embodiments, the rack-frame and module system is implemented in carts, cabinets, workstations, server racks, lab benches, trailers, or building-mounted stations. Vehicle embodiments may be powered by the vehicle system; stationary embodiments may be mains- or battery-powered. This paragraph supports use cases outside a hitch-mounted context.

Actuation. Swing motion can be manual or power-assisted using springs, gas struts, torsion bars, dampers, or motorized actuators (e.g., linear actuator, rotary actuator) with limit detection at closed, half-open, and full-open positions.

Locking and security. Latching may include over-center latches, pawl-and-ratchet, rotary latches, clevis pins with detents, padlock provisions, or keyed cylinders. Travel locks may be redundant, and a lockout feature may prevent deployment on roadways.

Tray geometry and accessories. Trays may be flat, dished, or contoured with replaceable wear surfaces. The tie-down matrix can include circular, oval, slotted, key-slot, or obround openings arranged in orthogonal and diagonal patterns to support common strap geometries and accessory mounts (e.g., quick-release posts, threaded inserts, T-nuts).

Structure. Cross members, ribs, and gussets may be formed from tube, channel, angle, hat section, or honeycomb panel. The hinge pin can be removable and captured, and bushings can be metallic, composite, or polymer with optional dust seals.

Stabilization. A stabilizer can be a single post, dual posts, or an adjustable jack coupled to the swing-arm. In deployed use, the stabilizer post is extended until a ground-engaging foot contacts the terrain and carries a share of the payload-induced load. By reacting a portion of the tray load directly into the ground, the stabilizer post reduces bending moments and deflection at the hinge region of the swing-arm and pivot mast that would otherwise result from the lever arm between the trays and the hitch receiver. The stabilizer may be screw-driven, cam-locked, or spring-biased, and may seat into a ground plate or pad to prevent sinking on soft terrain.

Lighting and signaling. Optional lighting (e.g., brake/turn/reverse repeaters) and reflectors can improve visibility. Wiring may route through internal channels with weather-sealed connectors and strain relief.

Retrofit and kit. The platform may be offered as a retrofit kit with brackets, spacers, or adapters for multiple hitch receiver sizes (e.g., 1.25 in, 2.0 in, 2.5 in), and for vehicles with rear-mounted spare tires or swing-doors. Kits may include instructions and hardware assortments for different vehicle geometries.

Generalized methods. Methods include installing, deploying, loading, securing, servicing, and stowing operations. Steps can be performed in any order, omitted, or repeated as suitable for a given use case. Optional verification steps can include confirming latch engagement (mechanically or via sensor), checking backplane power status, and verifying clearance relative to vehicle doors, tailgates, or obstructions.

Control and telemetry. A controller may receive signals from latch sensors, limit switches, load cells, or inertial sensors, and may log deployment state, load estimates, or shock events for maintenance or safety. A mobile device or vehicle interface can display status, alerts, and usage metrics and can gate power distribution to modules.

As discussed herein, the modular hitch rack system and its plurality of components may be used for a variety of activities. Some or all of these activities may use one or more of the components of the modular hitch rack system described herein or otherwise contemplated. A non-exhaustive list of activities include: sports tailgating, hunting, fishing, camping, construction, sports, outdoor movie viewing, video gaming, etc.

The modular hitch rack system of the present disclosure addresses a common problem to those using their vehicles for various activities. Using traditional hitch storage racks and devices, a user is typically unable to open a tailgate or cargo hatch/door without removing the traditional hitch storage rack. This is often difficult to do without unloading the cargo from the traditional rack first, then removing the cargo. Once the user has accessed the vehicle, the process must be reversed. This process wastes time and energy.

The modular hitch rack system of the present disclosure includes, in addition to the components and base structure as previously described, a hinge structure. As discussed, the hinge structure may be incorporated as a separate component, or integrated into the components, or the base structure, or a combination thereof. The hinge structure, regardless of its configuration, enables the components to move relative to the base structure, while remaining securely connected to the base structure. The hinge structure may allow the components to move separately relative to each other, or to move in unison with each other, depending upon the application and configuration of the components. The hinge structure may include a plurality of preset locking positions, such as fully closed, fully open, halfway open, or anywhere in between. The hinge structure may be configured to allow users to reposition the components relative to each other. This repositioning may be advantageous to move the components temporarily (such as to access the cargo area of the vehicle) or more permanently (such as to lower a component to reduce its drag on the vehicle's aerodynamics.

The modular hitch rack system is configured to operate with vehicles that include an exterior, rear-facing spare tire, such as the Jeep® Wrangler®, the Ford Bronco®, and the Land Rover Defender®. As these vehicles include a side-swinging door, the modular hitch rack system of the present disclosure is configurable to operate with these types of vehicles.

In some embodiments, the latch sensor comprises a Hall-effect sensor, inductive proximity sensor, optical interrupter, or limit switch positioned to indicate a latched state.

In some embodiments, the blind-mate backplane connector includes a floating mount that permits at least ±1.5 mm translational compliance and at least ±2 degrees angular compliance.

In some embodiments, the swing-arm includes a gas-spring or damper configured to control opening speed and reduce impact at end-stops.

In some embodiments, the tie-down matrix includes at least two-hole geometries selected from circular, slotted, and key-slot to facilitate orthogonal and diagonal strap routing.

In some embodiments, the stabilizer post includes a foot with a high-friction pad and a telescoping section with detents or a threaded jack.

In some embodiments, modules communicate identity and capability information to the rack via a wired or wireless interface to enable power budgeting and interlocks.

In some embodiments, trays are removable from the swing-arm via captive fasteners or quick-release pins to facilitate service, reconfiguration, or storage.

Claim scope. The features of any dependent claim may be combined with the features of any independent or other dependent claim unless such combinations are mutually exclusive. Functional language is intended to define capabilities without invoking 35 U.S.C. § 112(f) unless “means for” or “step for” is expressly recited.

Non-limiting examples. Examples and embodiments are illustrative and not limiting. Headings are for convenience only. Where exemplary dimensions, materials, or performance values are mentioned, they are provided to aid understanding and do not limit the claims.

Variations and equivalents. Modifications and equivalents of the disclosed structures and methods will be apparent to those of ordinary skill in the art. Such modifications and equivalents are intended to fall within the scope of the appended claims.

Various modifications and alterations to the specific embodiments described above will be apparent to those skilled in the art. All such variations are included within the scope and spirit of the disclosure.

The preceding examples illustrate embodiments of the disclosure, but should not be viewed as limiting the scope of the disclosure.

Other embodiments and uses of the disclosure will be apparent to those skilled in the art from consideration of the specification and practice of the disclosure as disclosed herein. All references cited herein, including all publications, U.S. and foreign patents and patent applications, are specifically and entirely incorporated by reference. The term comprising, wherever used, is intended to include the terms consisting and consisting essentially of. Furthermore, the terms comprising, including, and containing are not intended to be limiting. It is intended that the specification and examples be considered exemplary only with the true scope and spirit of the disclosure indicated by the following claims.

### Overview and Terminology

As used herein, MS2 Racked and modular hitch rack refer to the same inventive platform. References to front, rear, left, and right are from the perspective of an observer standing behind the vehicle.

Referring generally to the drawings, an illustrative embodiment of the modular hitch rack 100 includes an upper rack/carrier 102 supported by an upper carrier arm 103. Lower rack/carrier 104 is disposed (in some configurations) below upper rack (or tray) 102. Upper carrier stabilizer/support leg 106 is connected to upper rack 102 and/or upper carrier arm 103 on one end and the opposite end of upper carrier stabilizer 106 is connected to main frame 110. Main frame 110 supports lower rack 104 and hitch mount 108. Upper rack 102 and lower rack 104 may include a deck surface 107. In some embodiments, the support arm/upper carrier stabilizer 106 and main frame 110 functions as a pivot mast coupled to the vehicle V via the hitch mount 108, which is configured as a receiver insert for a hitch receiver of the vehicle V. Upper carrier stabilizer 106, together with any attached cross members and trays/racks 102, 104, functions as a swing-arm pivoting about hinge 114 relative to the main frame 110. Hitch mount 108 may be configured as a receiver insert sized to be received in a standard hitch receiver (e.g., 1.25 in, 2.0 in, or 2.5 in square tube) and secured with a hitch pin and clip.

Upper rack 102 and lower rack 104 may include guardrails 112 disposed, for example, about the perimeter of upper rack 102 and/or lower rack 104. Main frame 110 also includes one or more hinge/pivots 114. Hinge 114 is connected to upper carrier stabilizer 106 and allows it (and upper rack 102) to rotate about hinge 114. In operation, hinge 114 includes one or more locking pins 121 to prevent rotation of hinge 114. Upon activation of pin 121, hinge 114 allows upper rack 102 to rotate from a first (stowed) position behind tailgate T of vehicle V to a plurality of positions in an arc centered on hinge 114.

Upper carrier stabilizer 106 may include a height adjustment device 118. Height adjustment device 118 may include a pin 121 to secure upper rack 102 in a plurality of vertical positions.

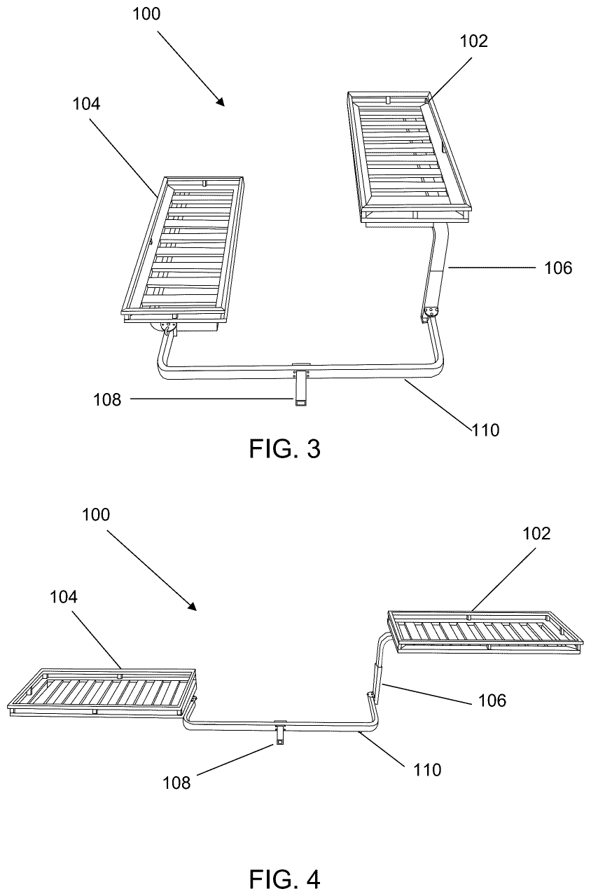

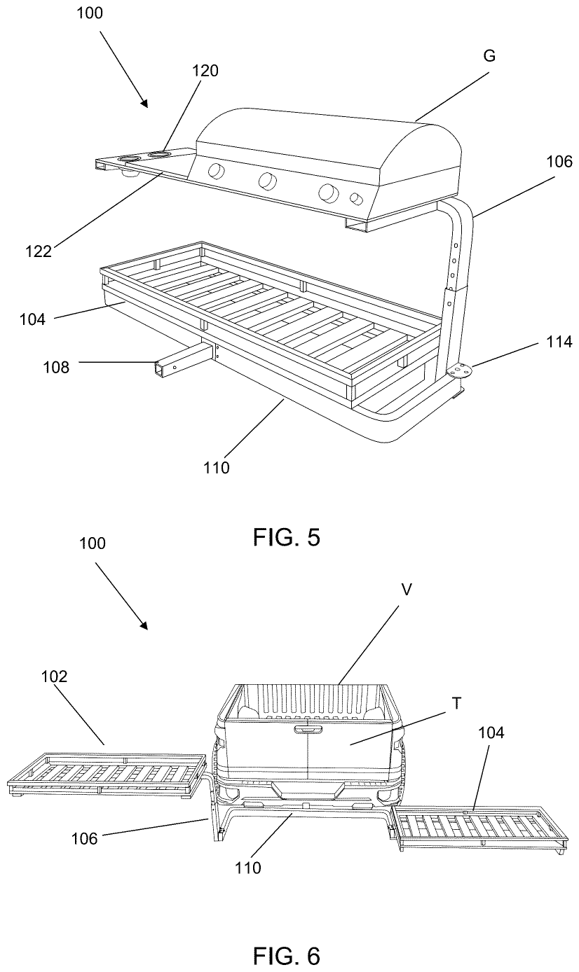

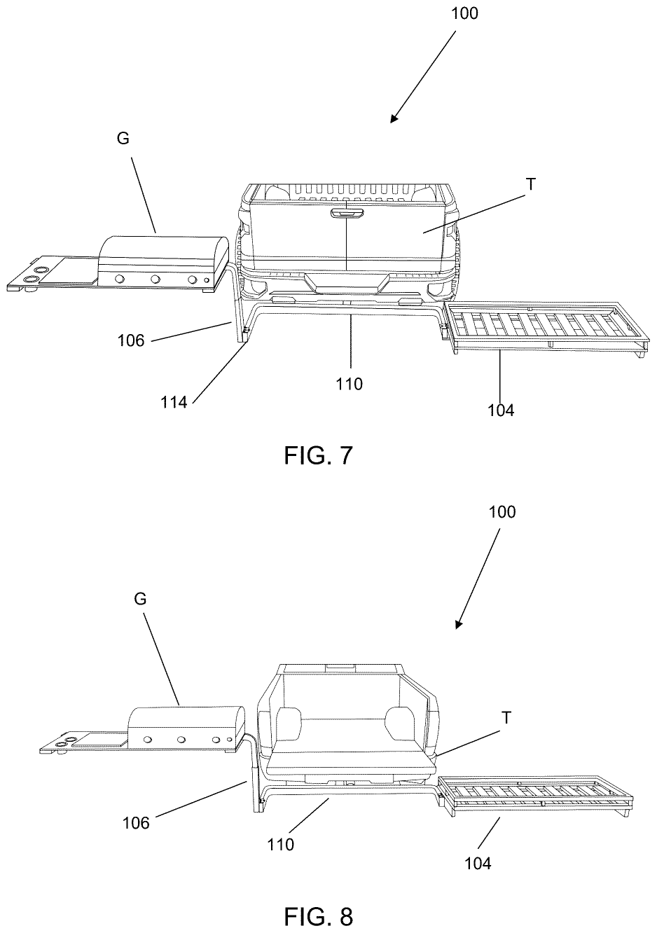

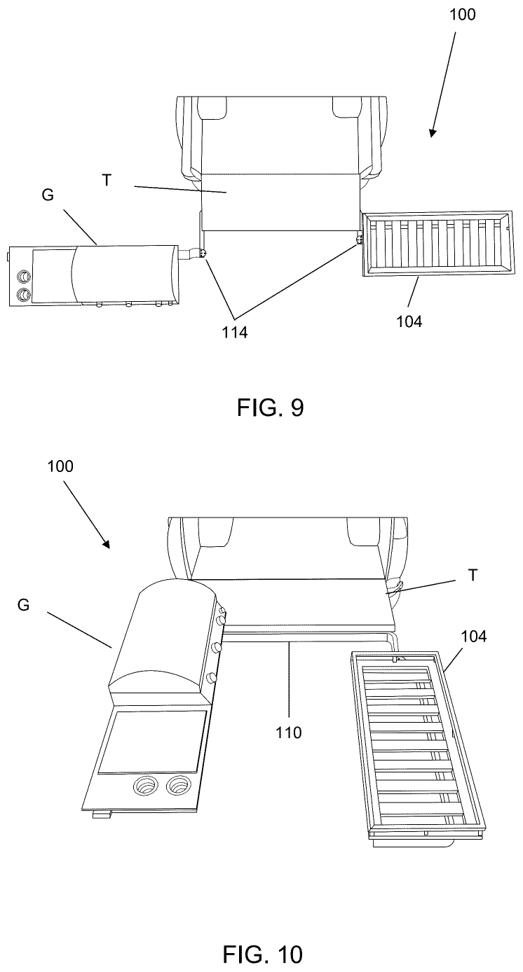

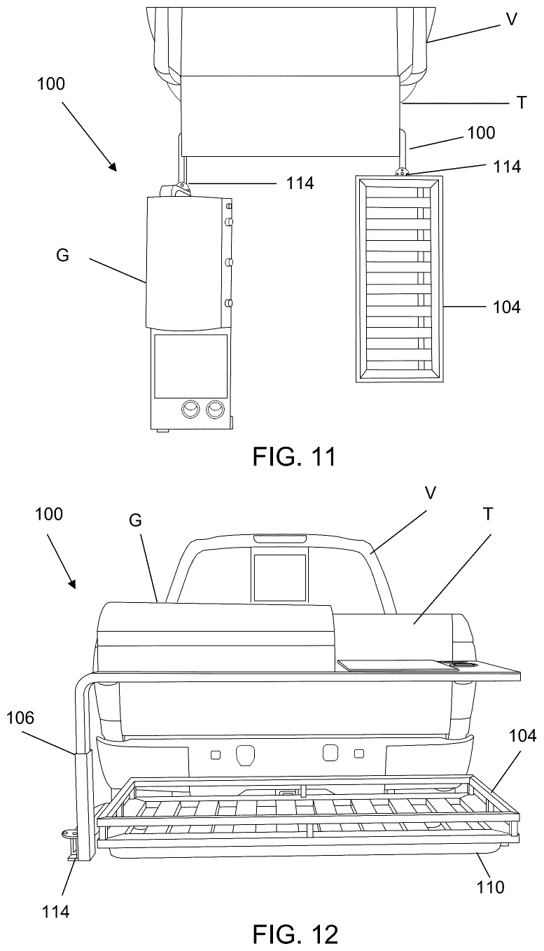

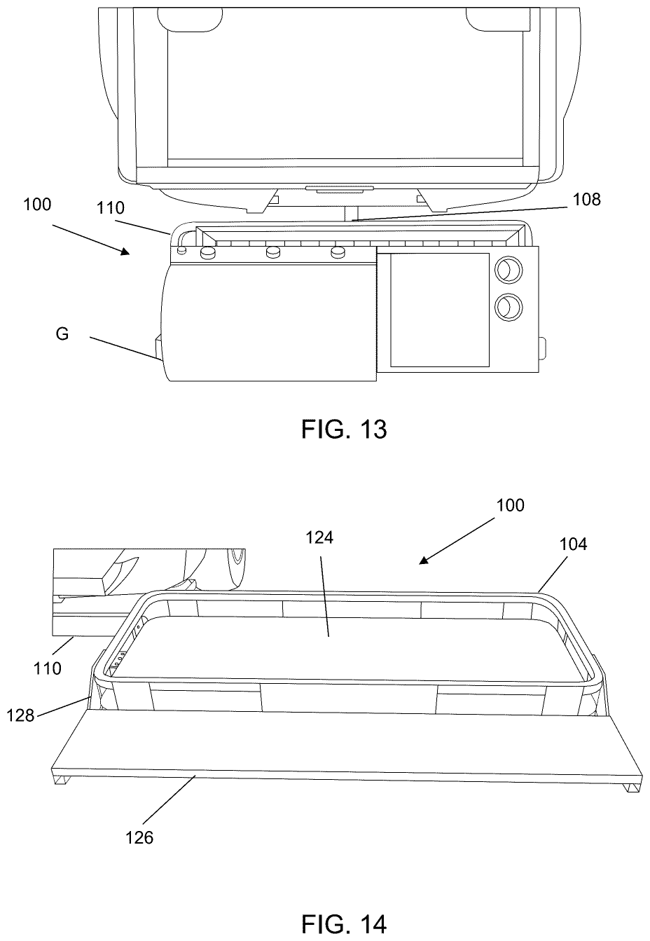

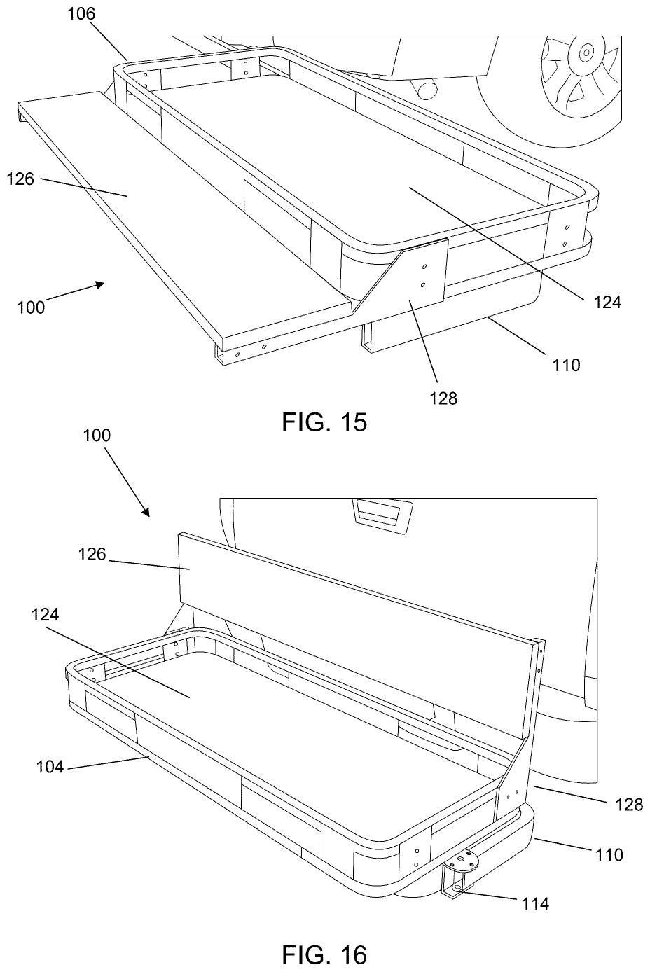

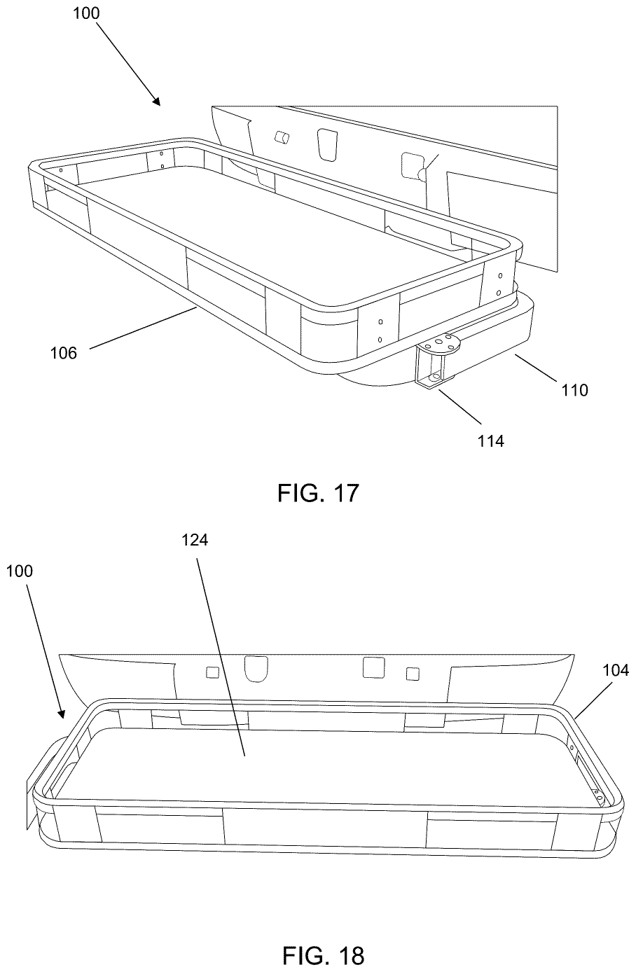

Referring now to FIGS. 3 and 4 and other Figures herein, upper rack 102 may be rotated from a stowed position in proximity to tailgate T to a position approximately 90 degrees from tailgate T. Similarly, lower rack 104 may also be rotated from a stowed position in proximity to tailgate T to a position also 90 degrees from tailgate T—thereby exposing the tailgate T of vehicle V. In these positions, a user may access vehicle V via the open tailgate T (or in the case of other vehicles without a tailgate, a truck, cargo area, etc.). FIG. 4 illustrates a further rotational deployment of upper rack 102 and lower rack 104, 180 degrees from the original stowed position behind tailgate T.

Referring generally to the Figures, in some embodiments grill G replaces upper rack 102 in modular hitch rack 100. Grill G may also include cupholders 120 and cutting board 122. Similar in operation to upper rack 102, grill G may be rotated from a stowed position behind tailgate T to positions including, but not limited to, 90 or 180 degrees from the stowed position.

In other embodiments, lower rack 104 may include an internal platform 124 and an external platform 126. In this configuration, lower rack 104 may be utilized, for example, as a seat by rotating external platform 126 via a pair of platform hinges 128. In operation, for example, the seat formed by lower rack 104 equipped with internal platform 124 and/or external platform 126 may provide a seating surface for one or more users. Similarly, as described above, lower rack 104 so equipped may be rotated from the stowed position to other positions as desired.

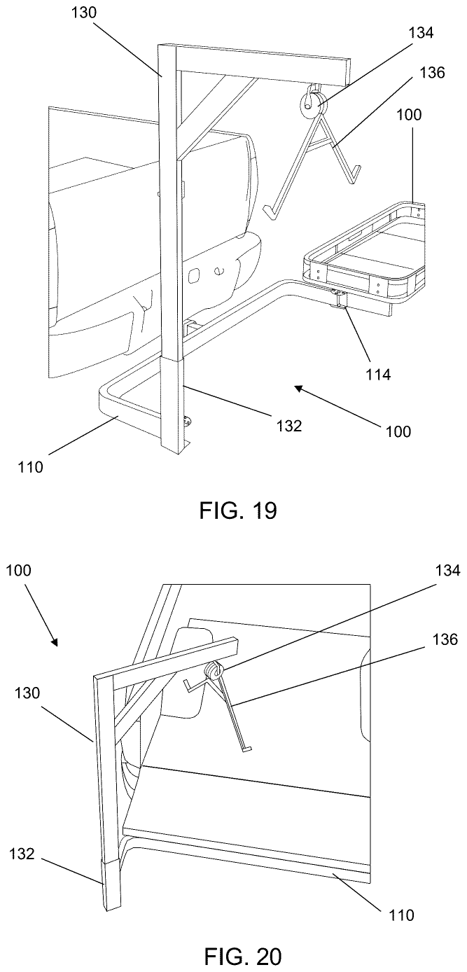

Referring now to FIGS. 19 and 20, upper rack 102 may be replaced by a hoist arm 130 and hoist attachment 132. Hoist 134 is attached to hoist arm 130 and includes hoist hook 136. Hoist arm 130, hoist attachment 132, hoist 134 with hook 136 may be rotated via hinge 114 mounted to main frame 110. For example, and without limitation, hoist 134 may be used to load or unload cargo from vehicle V. In other embodiments, hoist 134 and hook 136 may be used to lift and hold a hunted deer, then optionally loaded it in vehicle V.

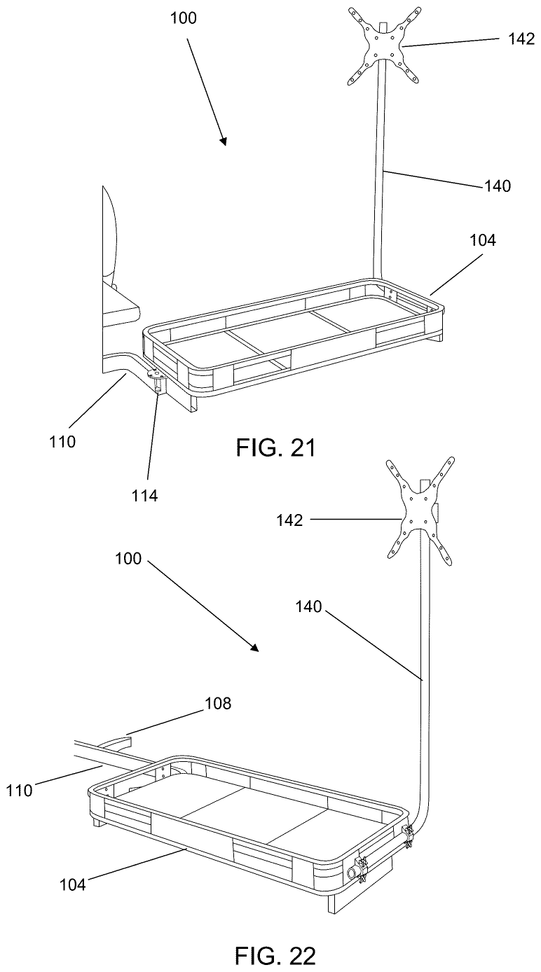

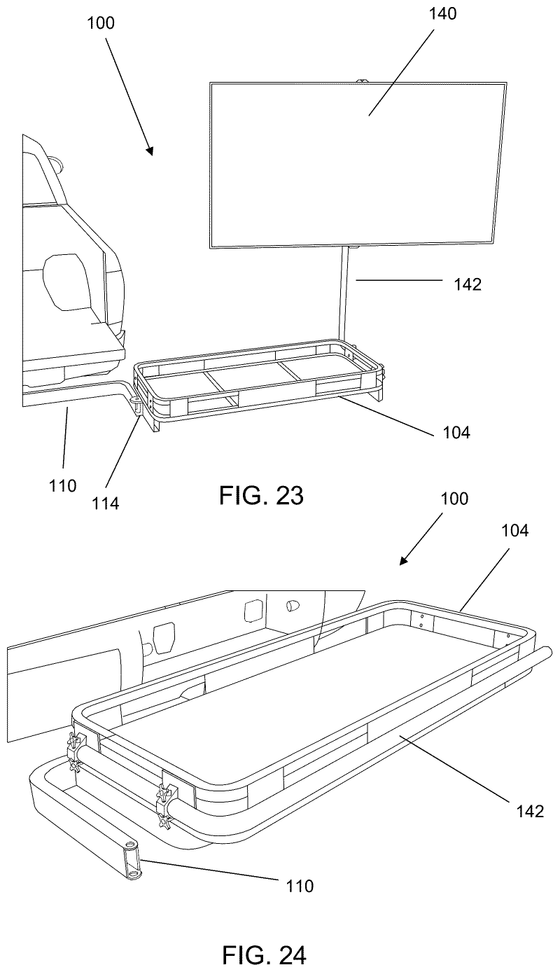

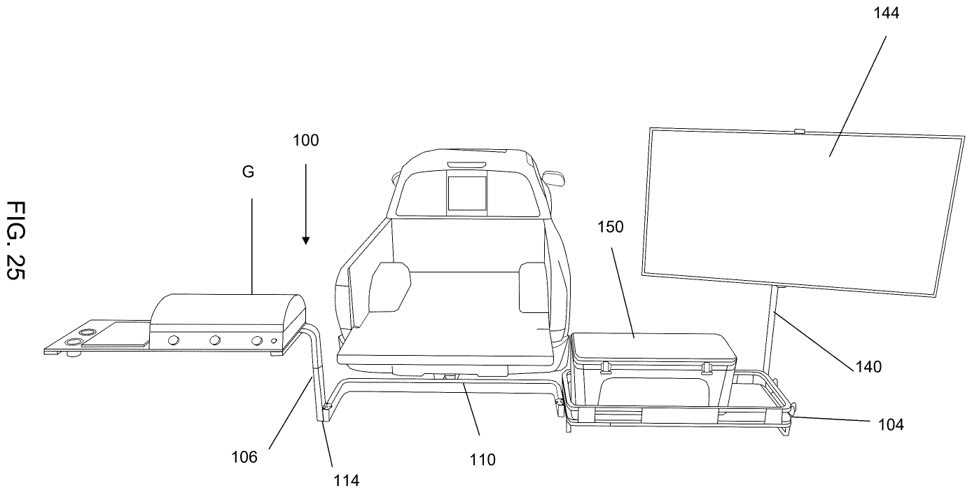

In other embodiments, lower rack 104 (or upper rack 102) may be supplemented by adding TV/screen stand 140 with TV/stand mount 142 (see FIGS. 21-22, etc.). TV/stand mount 142 is configured to secure a TV screen or a movie screen. In operation, rotating lower rack 104 equipped with TV/screen stand 140 allows a user to position the TV or screen in a desired position within the rotational arc using hinge 114. Stand 142 may be stowed alongside lower rack 104 (or upper rack 102) when not in use (see FIG. 24.).

In some vehicle-mounted implementations, the bay corresponds to an accessory region on a hitch rack platform, and the modules include accessory units such as storage racks, grills, hoists, or work surfaces that are received in the bay and secured at a seated position by quick-release latch hardware without requiring the modules to slide along guide rails.

FIG. 25 illustrates another embodiment of the present invention. On the left side of the vehicle V, the modular grill G is installed on the modular hitch rack 100 via upper carrier stabilizer 106 and is rotatable via hinge 114 secured to main frame 110, which is in turn secured to vehicle V via hitch mount 108. On the opposite side of hitch rack 100, lower rack 104 is also secured to main frame 110, but via a second hinge 114. Stowed within lower rack 104 is cooler 150. Also attached to lower rack 104 is TV stand 140 and TV mount 142 that is securely holding TV 144.

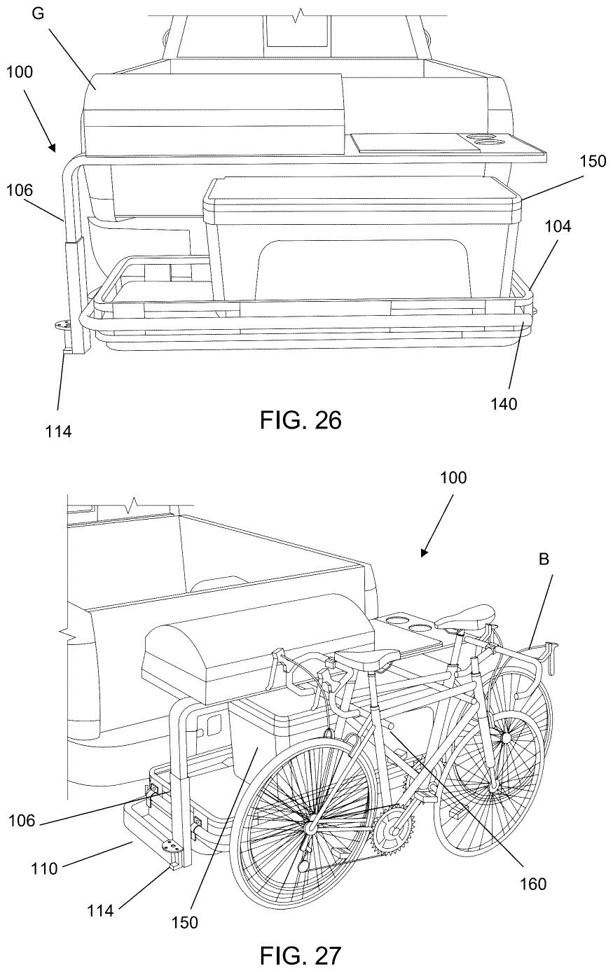

FIG. 26 illustrates yet another configuration of the modular hitch rack 100. In this configuration, grill G is located on the left, supported by upper carrier stabilizer 106 and rotationally movable via hinge 114 connected to main frame 110. Beneath grill G is lower rack 104 containing cooler 150 and also including a stowed TV stand 140.

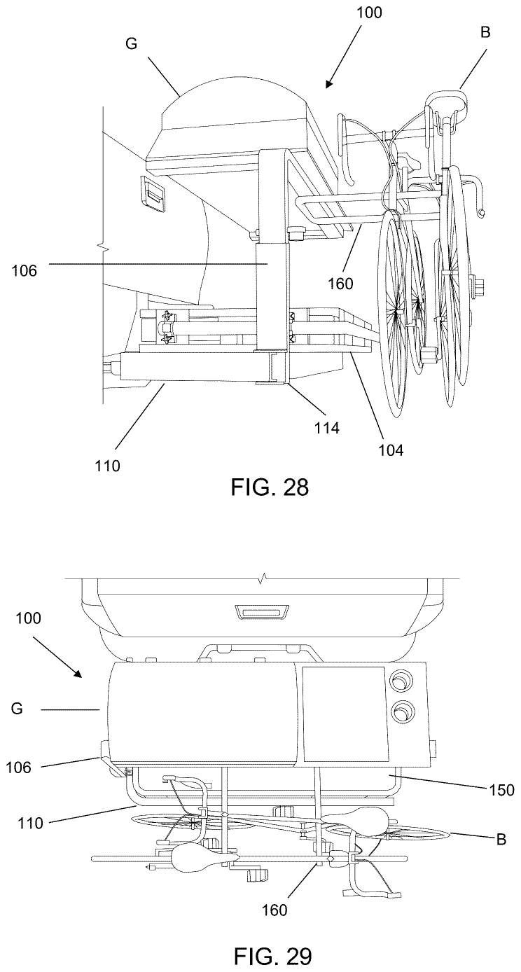

FIGS. 27-29 illustrate another embodiment of the modular hitch rack 100. In addition to the configuration shown in FIG. 26, a bike rack 160 is added to grill G (or upper rack 102, in other embodiments). Bikes B may be stowed on the bike rack 160 and using the hinge 114, grill G and bike rack 160 may be rotated about hinge 114 to allow access to grill G, vehicle V, etc.

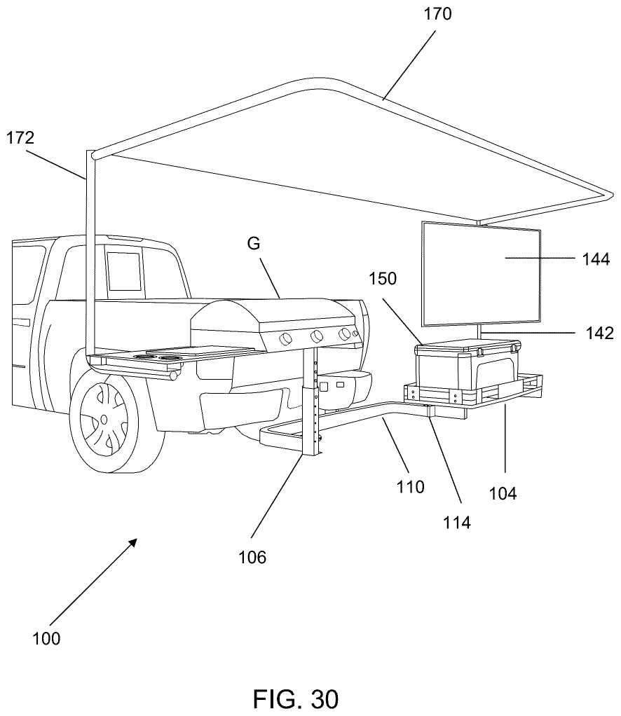

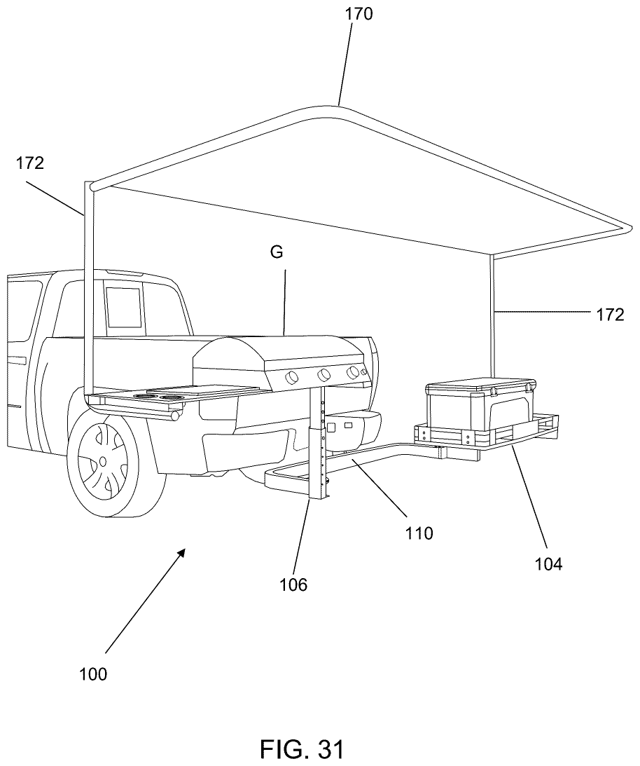

FIGS. 30-31 illustrate another embodiment of the hitch rack 100 of the present disclosure. In this embodiment, mounted to grill G (or upper rack 102 or lower rack 102) is canopy support 172 that mounts canopy 170. Depending on the positioning of canopy 170 and canopy support 172 (as well as grill G, in this embodiment), canopy 170 may be positioned to provide shelter underneath an area in proximity to the hitch rack 100.

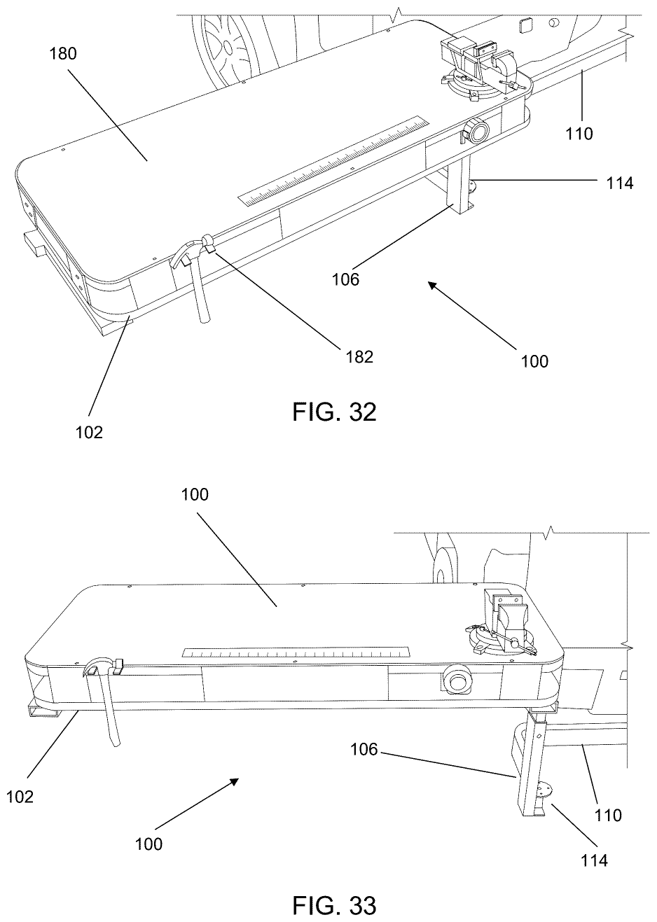

FIGS. 32-33 illustrate another embodiment of the hitch rack 100. In this embodiment, upper rack 102 is supplemented with work surface 180. It is anticipated that work surface 180 may be configured in a separate module apart from upper rack 102 (or lower rack 104). Work surface 180 may include one or more tool holders 182, a vice 184 and a measuring guide 186. Work surface 180 allows the hitch rack 100 to be used as a portable work location, such as for a carpenter or homeowner, whereby supplies stored in connected vehicle V may be easily accessed (especially via tailgate T, for example).

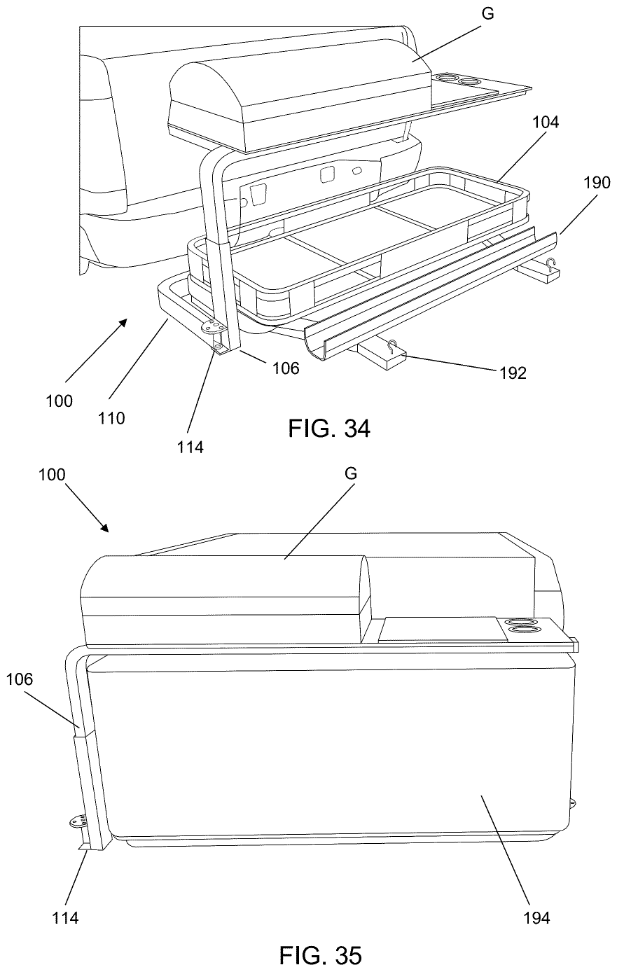

FIG. 34 illustrates another embodiment, grill G with lower rack 104 and cargo tray 190. Cargo tray 190 may be used to transport or store cargo of various shapes and sizes. Cargo tray 190 is mounted to cargo tray arms 192, which are connected to main frame 110 and/or lower rack 104.

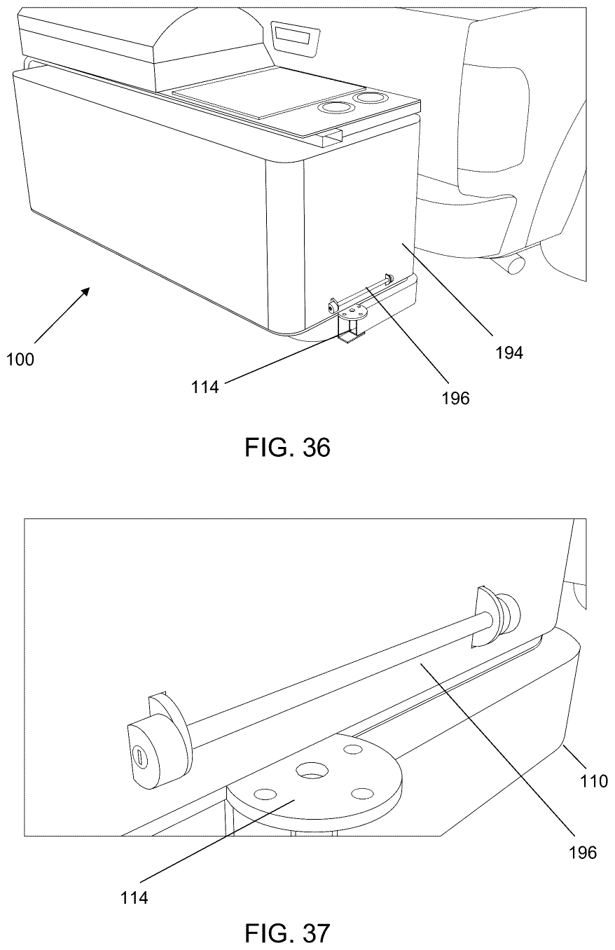

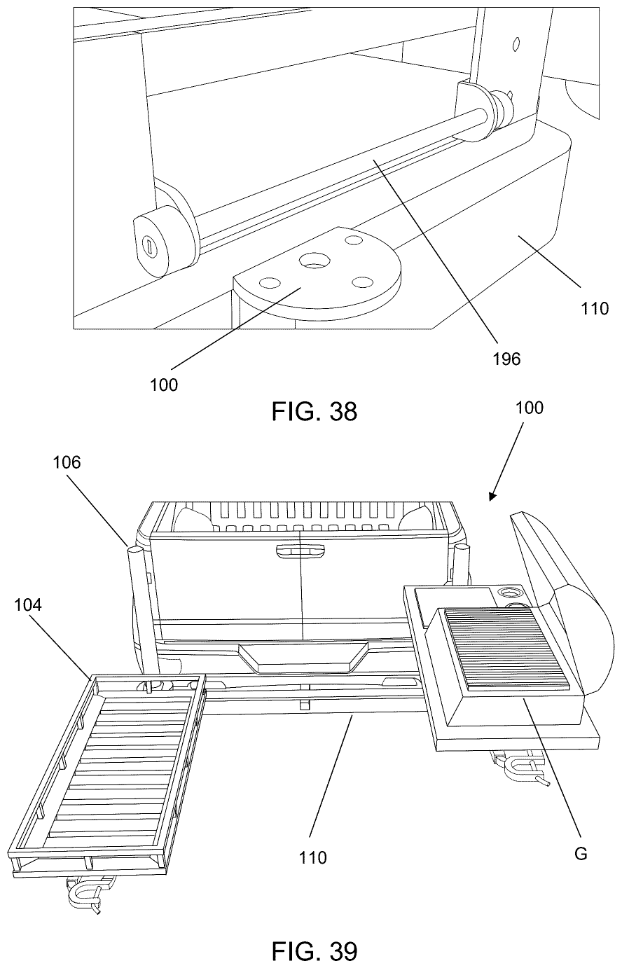

FIGS. 35-38 illustrate another embodiment of hitch rack 100. Grill G is shown in the upper location and beneath grill G is storage box 194 in the lower location (in the position of lower rack 104 in other embodiments). Storage box 194 also includes storage box handle 196.

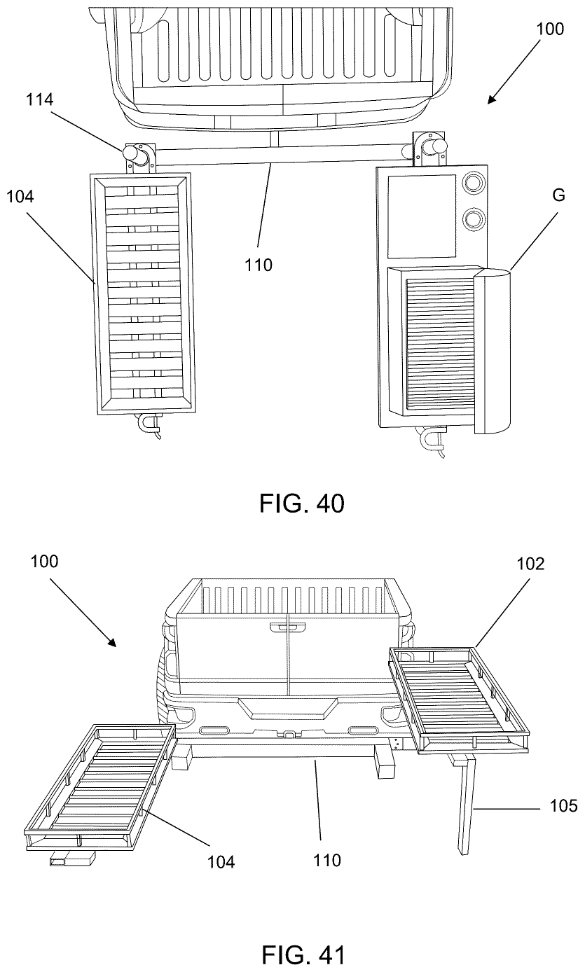

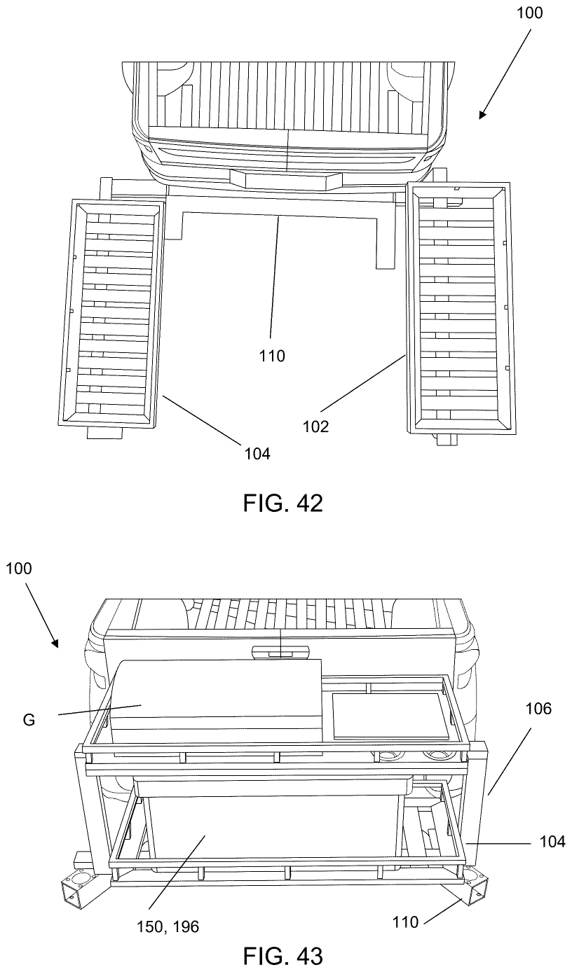

FIGS. 39-42 illustrate various configurations of hitch rack 100. In one embodiment shown in FIGS. 39-40, lower rack 104 is on the left, while grill G is shown on the right. The position of the modules is determined by user preference and is limited only by the user's imagination or needs at the time of use. FIGS. 41-42 illustrate another configuration, with lower rack 104 on the left and upper rack 102 on the right. In this embodiment, a support arm 105 is added to upper rack 102 to provide additional weight capacity to upper rack 102. Similarly, as shown herein, a support arm 105 may be added to lower rack 104 (and other modules).

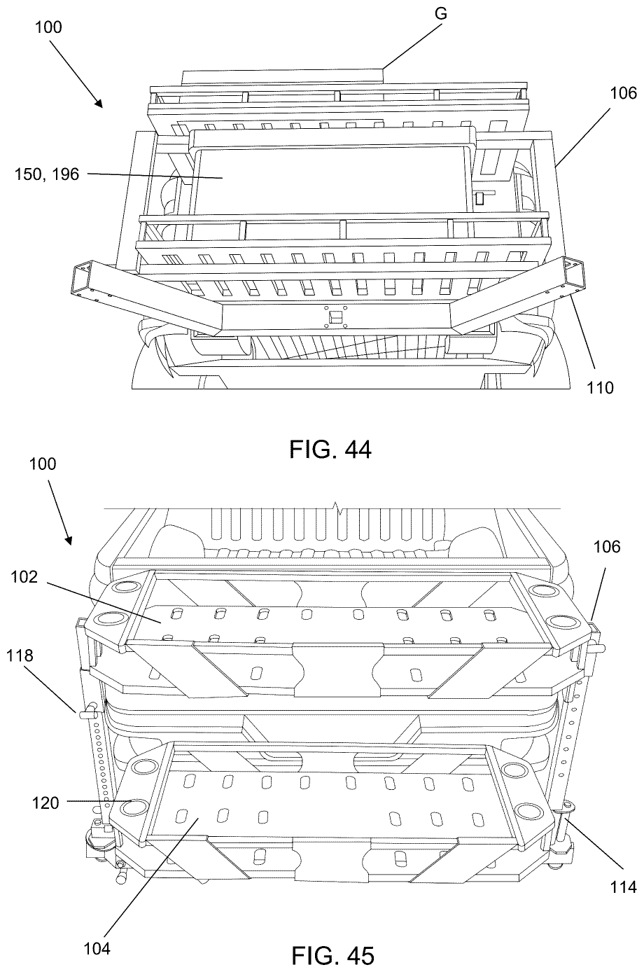

FIGS. 43-44 illustrate another embodiment of the hitch rack 100. Grill G is shown mounted on the left, and lower rack 104 is shown (with cooler 150) mounted on the right. For increased capacity, main frame 110 extends under lower rack 104.

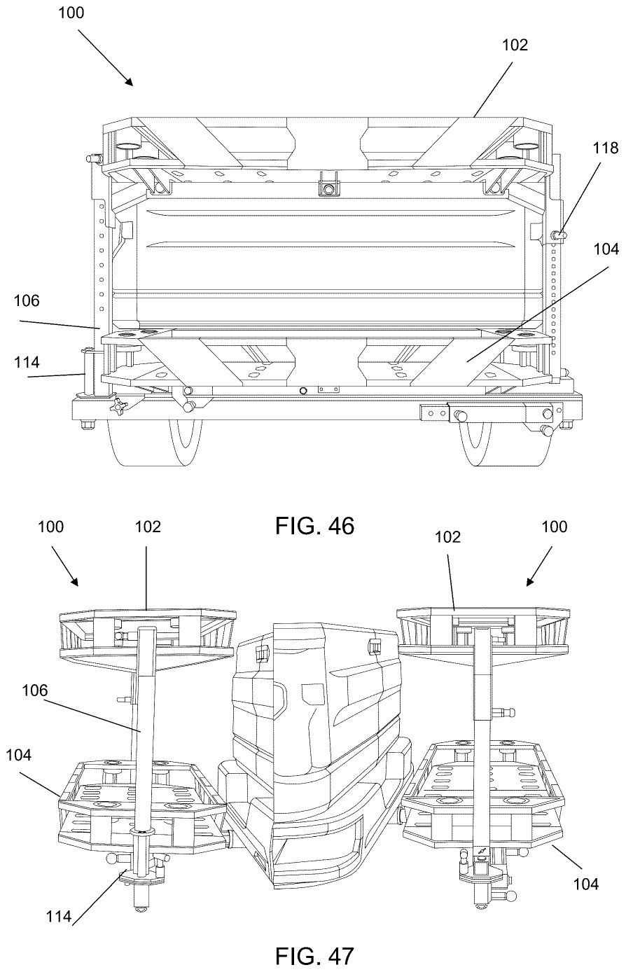

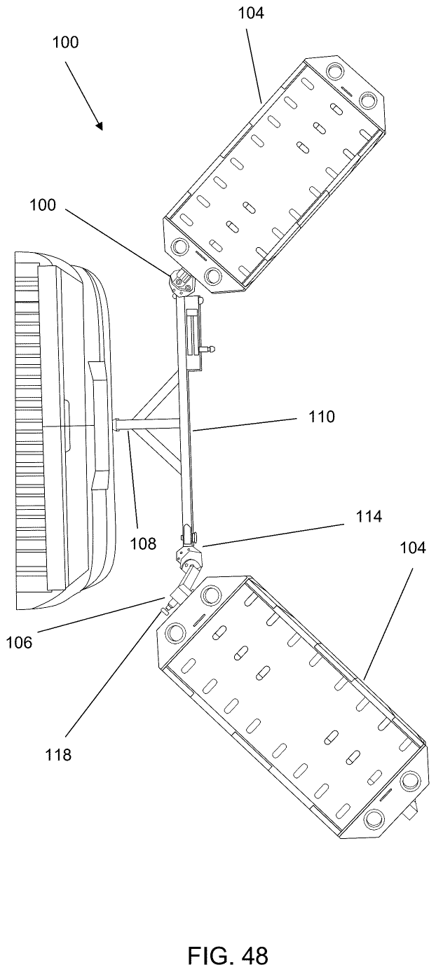

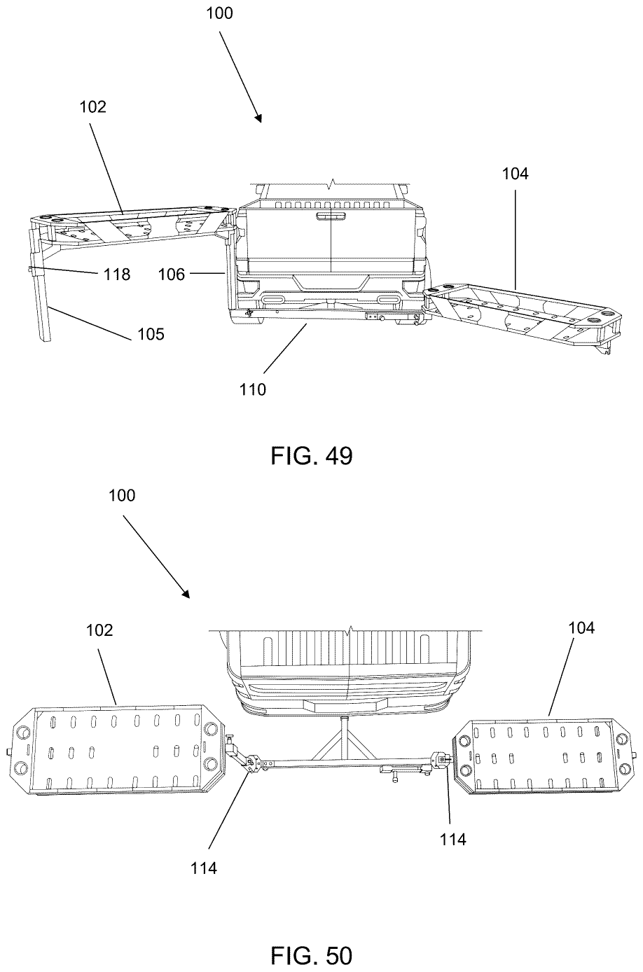

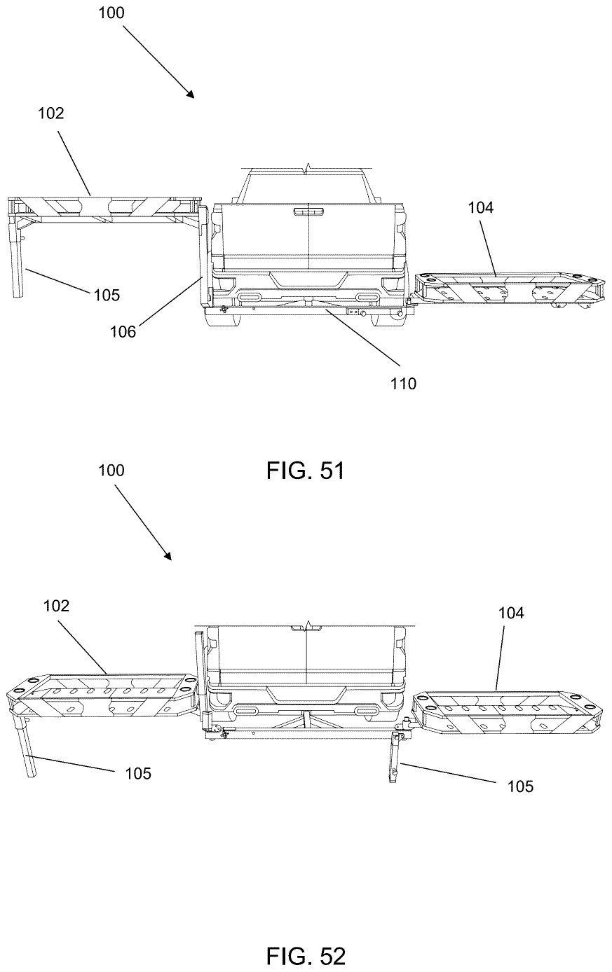

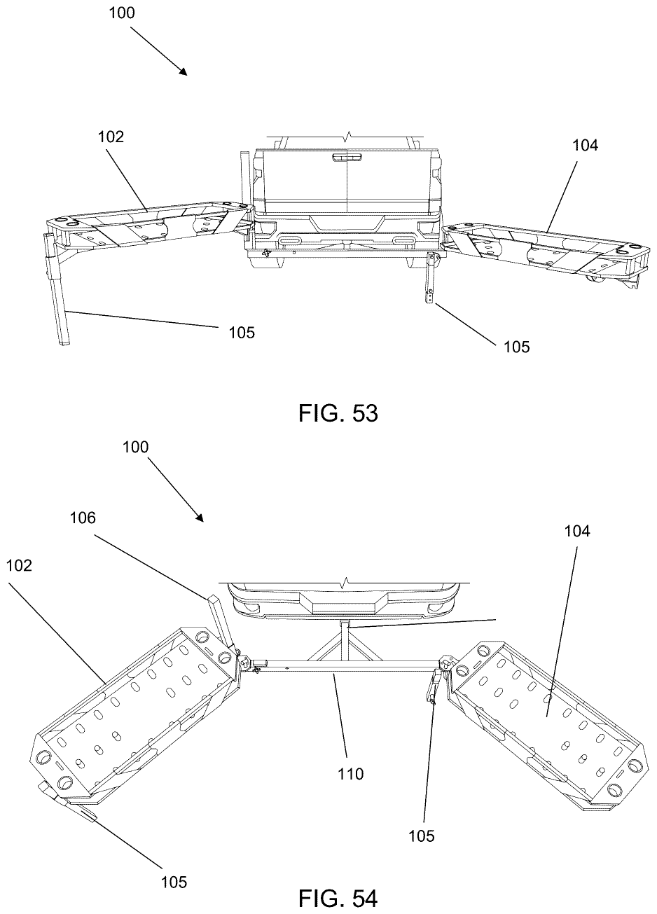

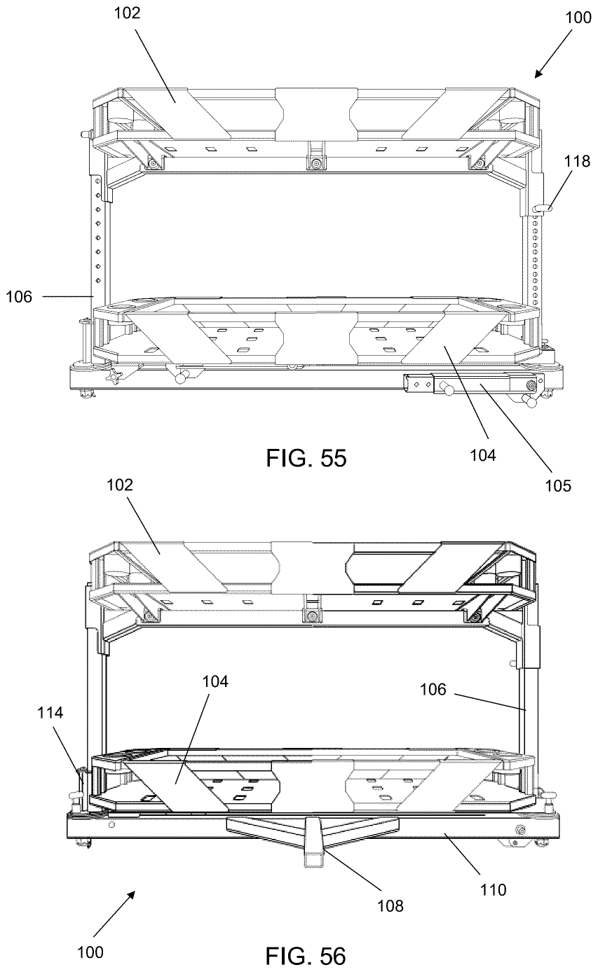

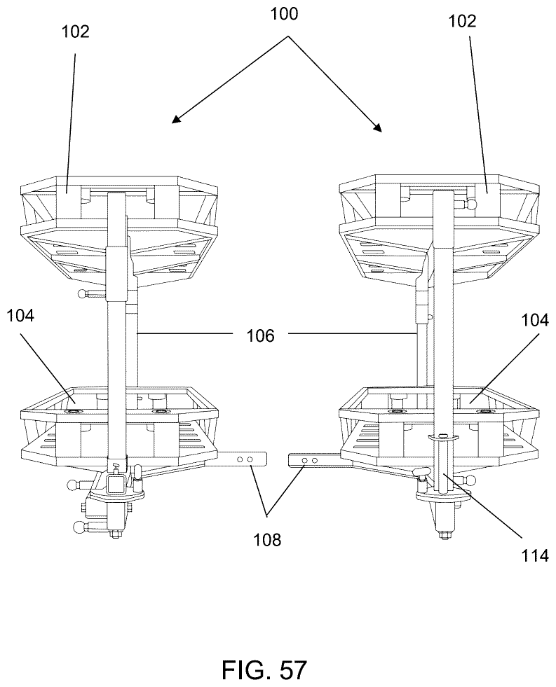

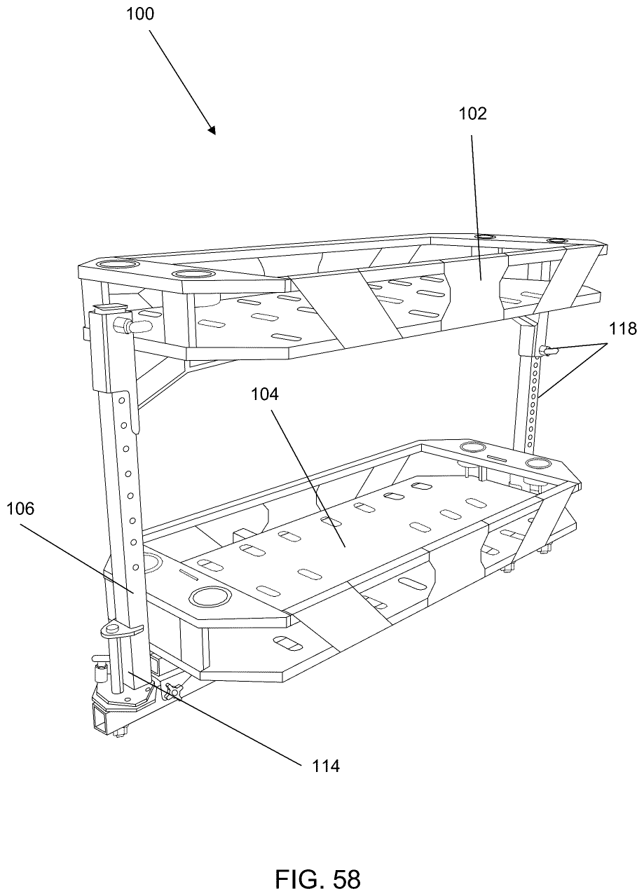

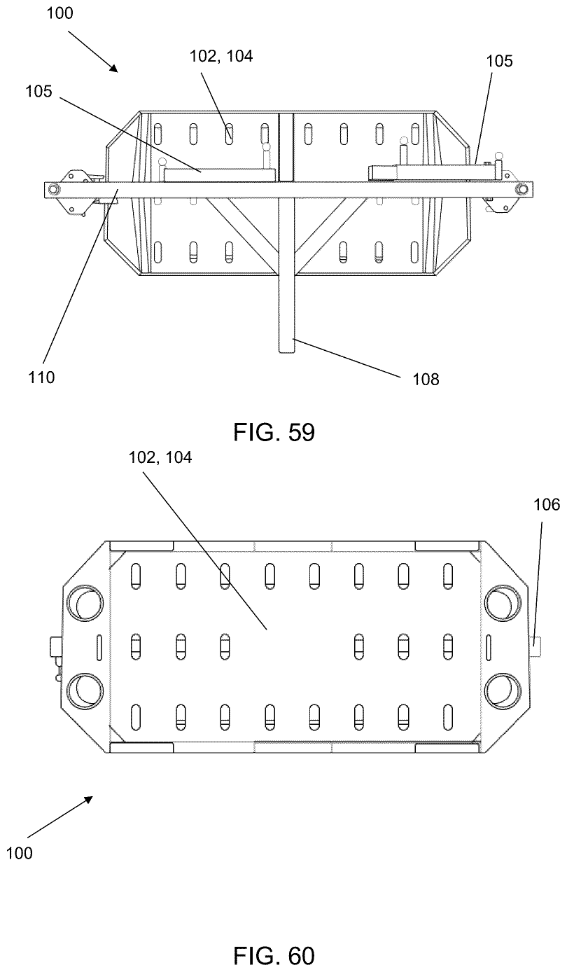

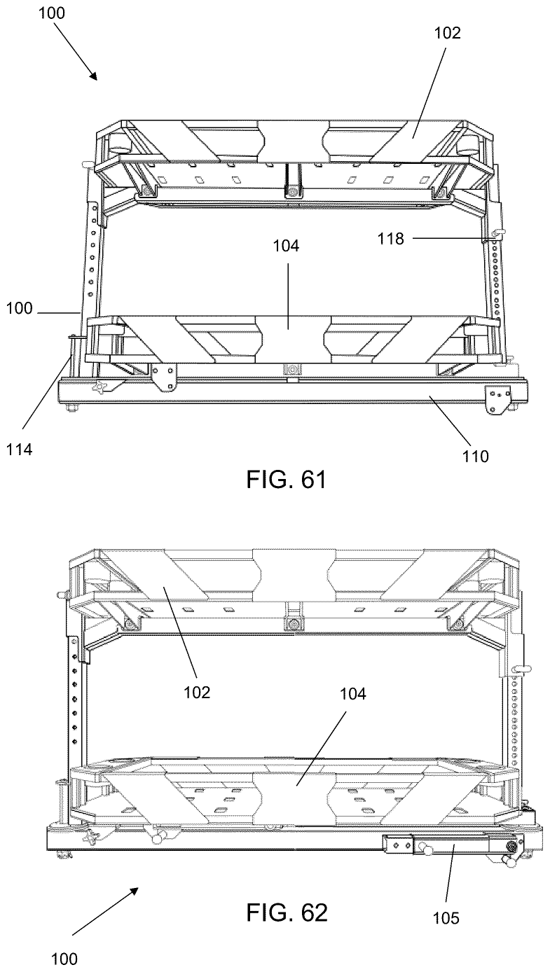

FIGS. 45-46 illustrate the higher capacity embodiment of hitch rack 100 shown in FIGS. 43-44, but with upper rack 102 substituted for grill G. In this embodiment, both upper rack 102 and lower rack 104 include cupholders 120. FIGS. 47-62 illustrate different views of the same embodiment; however, in FIG. 52 for example, support leg 105 is shown giving additional weight capacity to both upper rack 102 and lower rack 104.

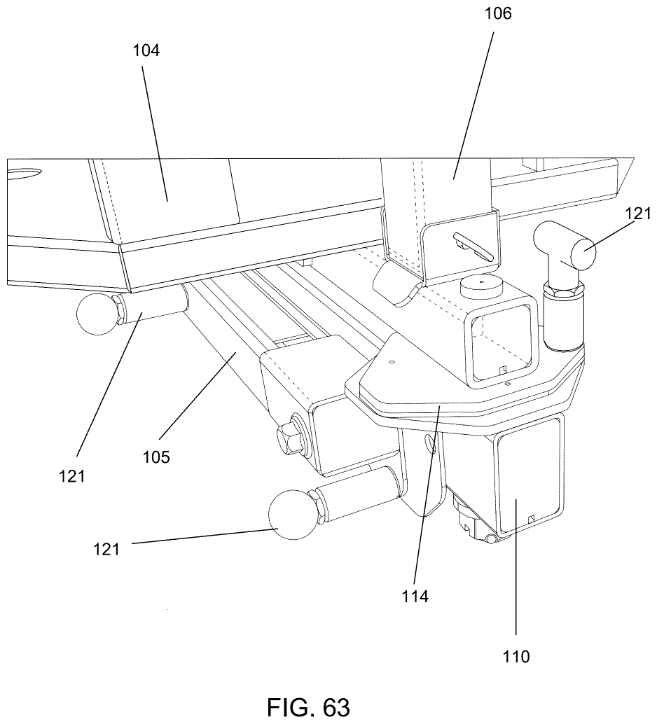

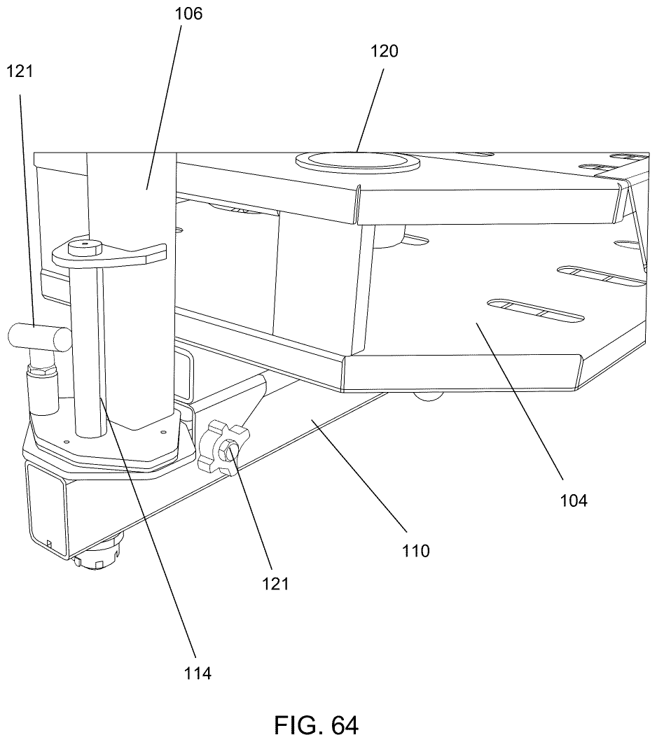

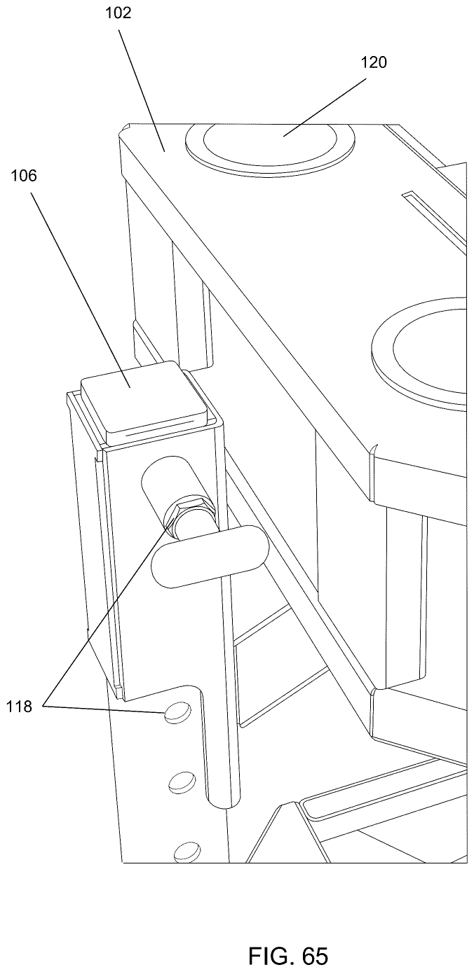

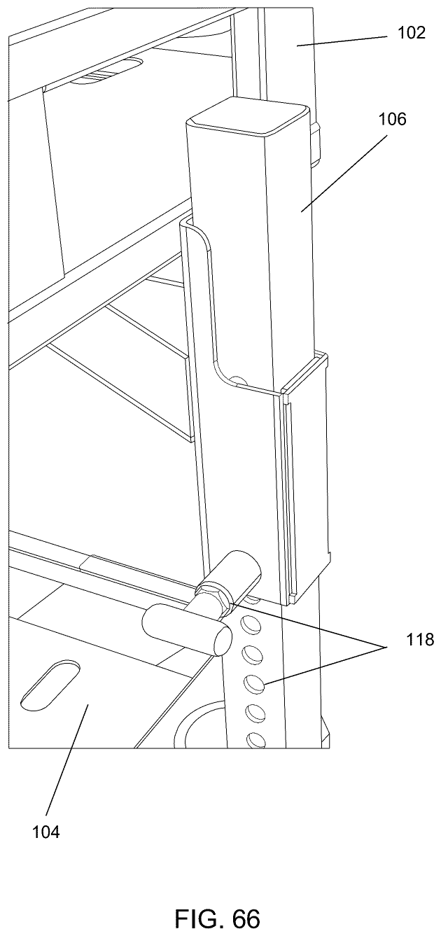

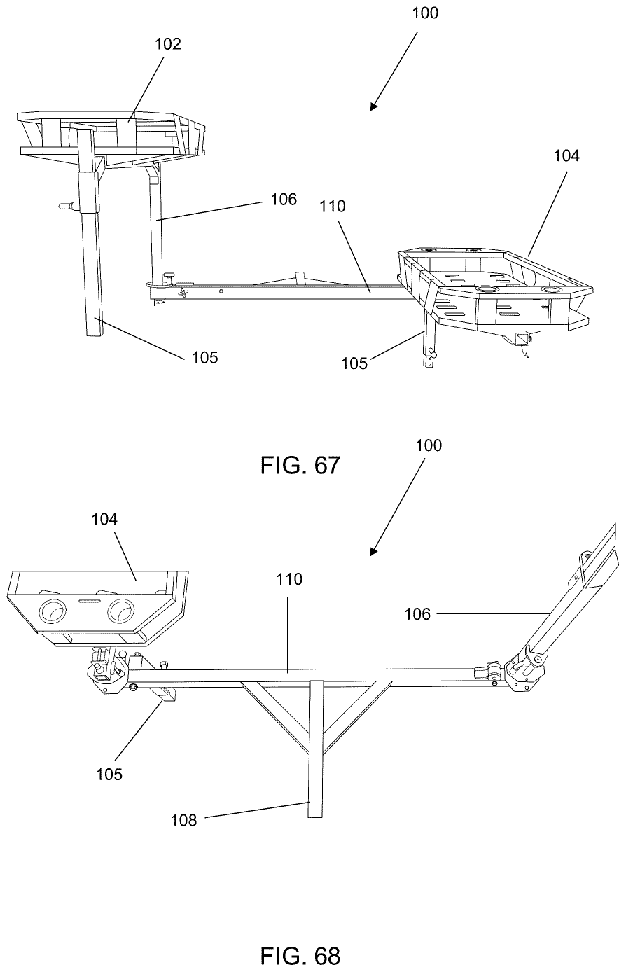

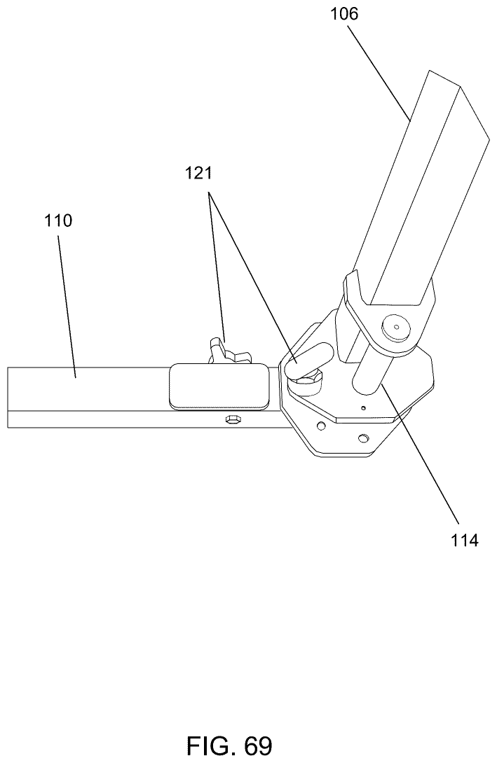

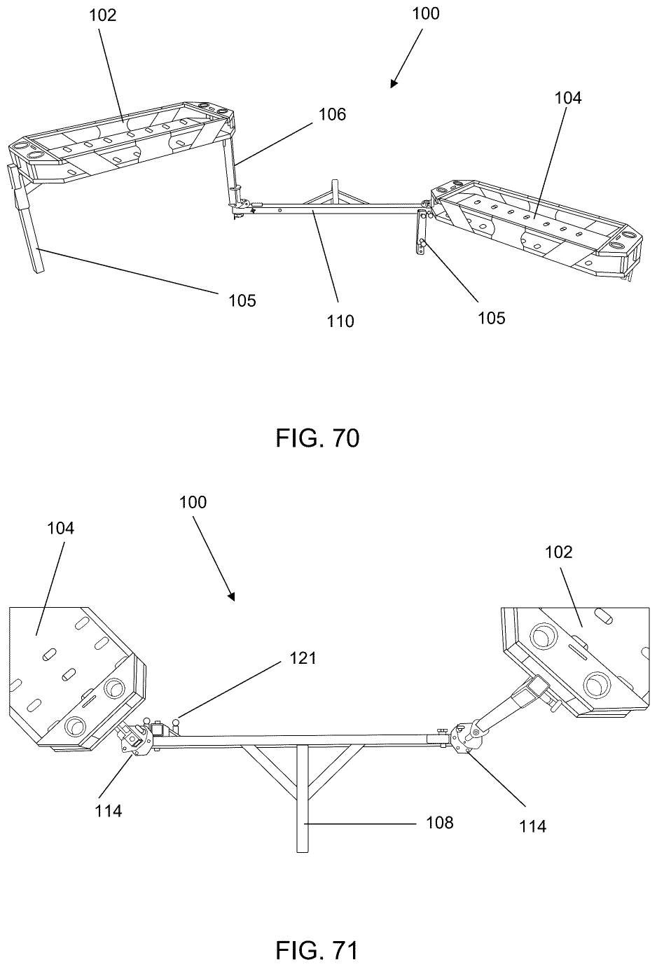

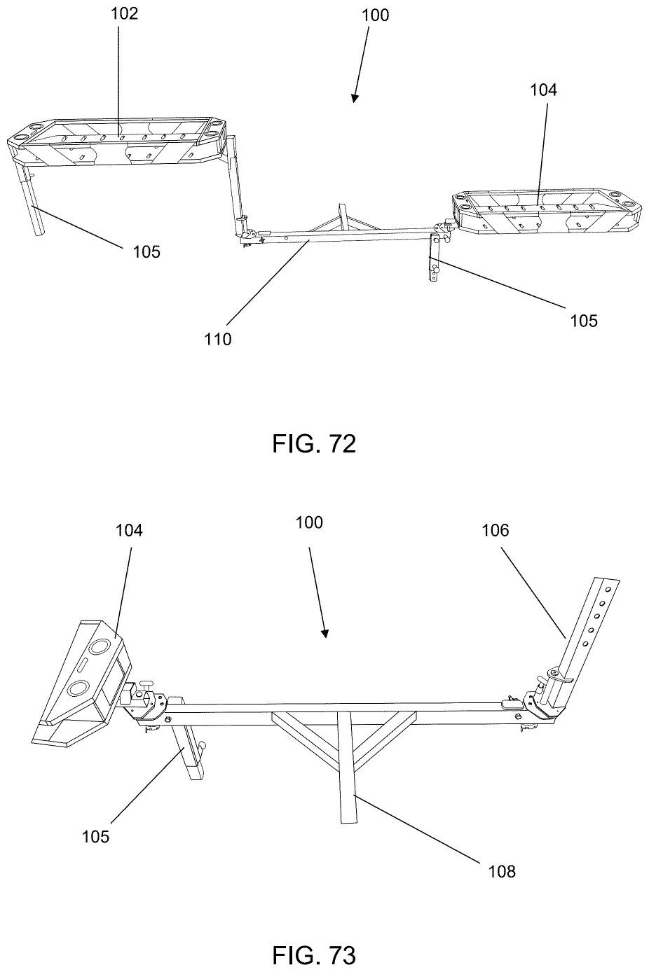

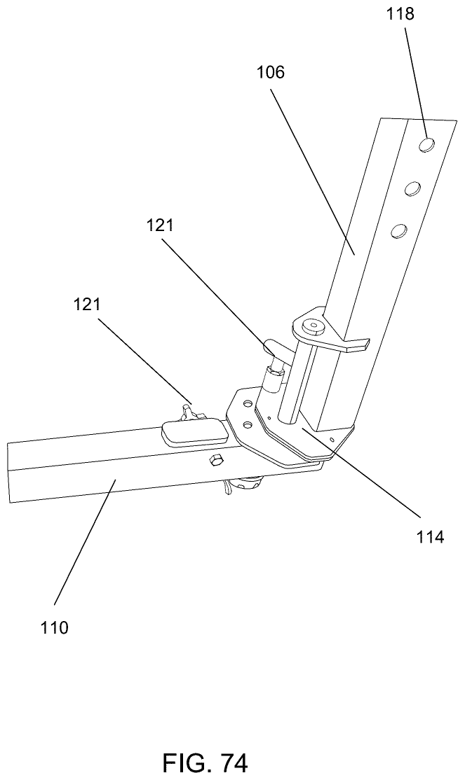

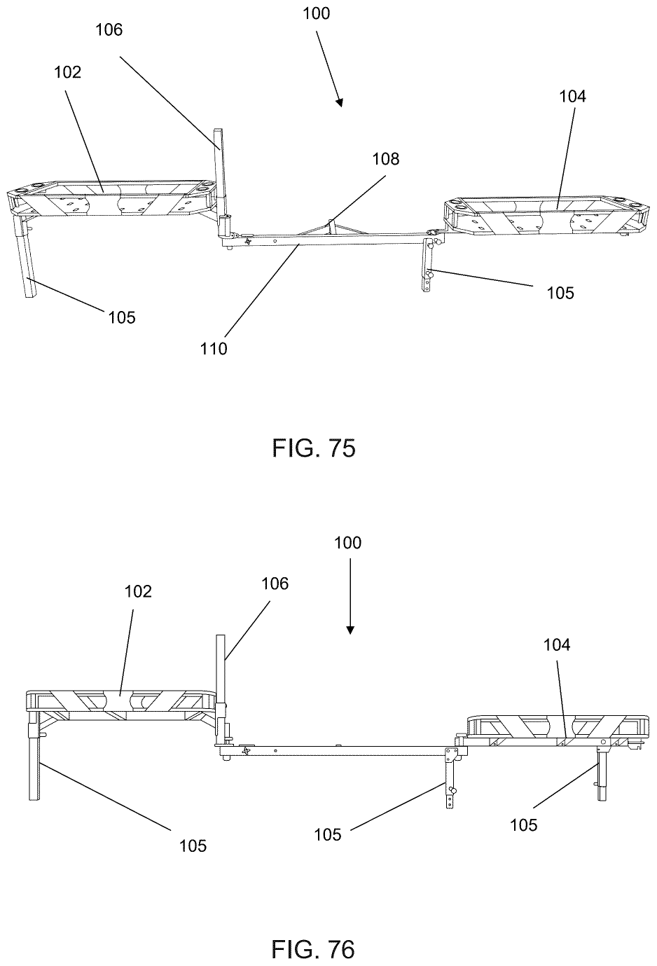

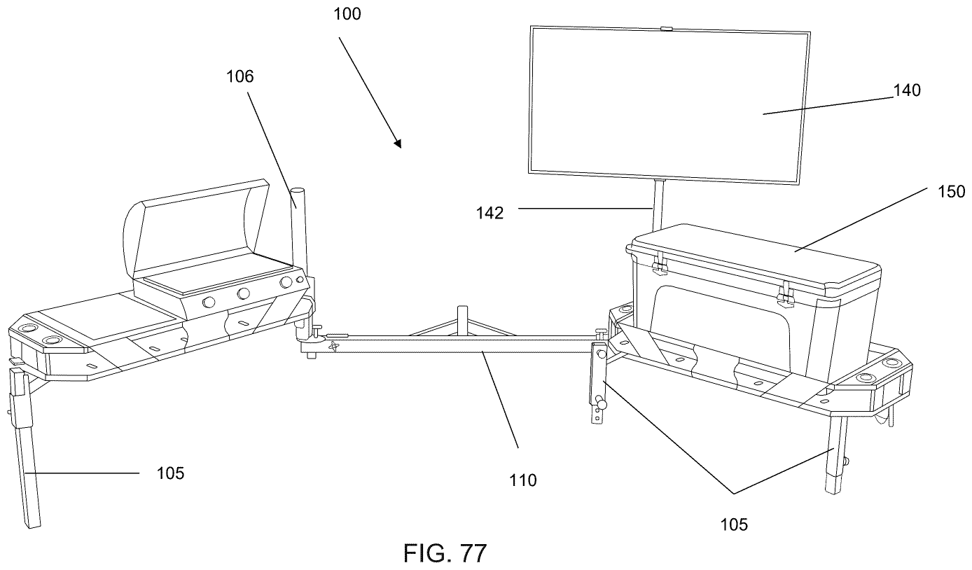

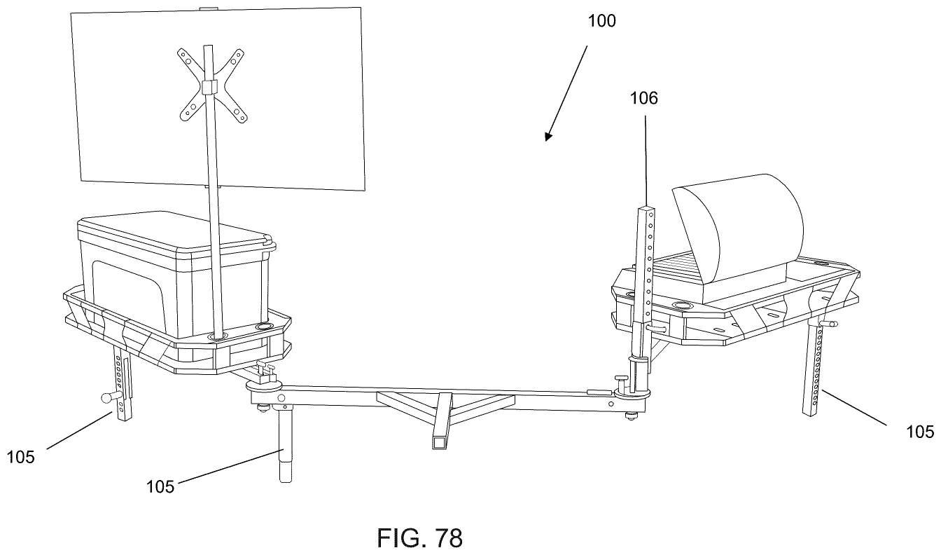

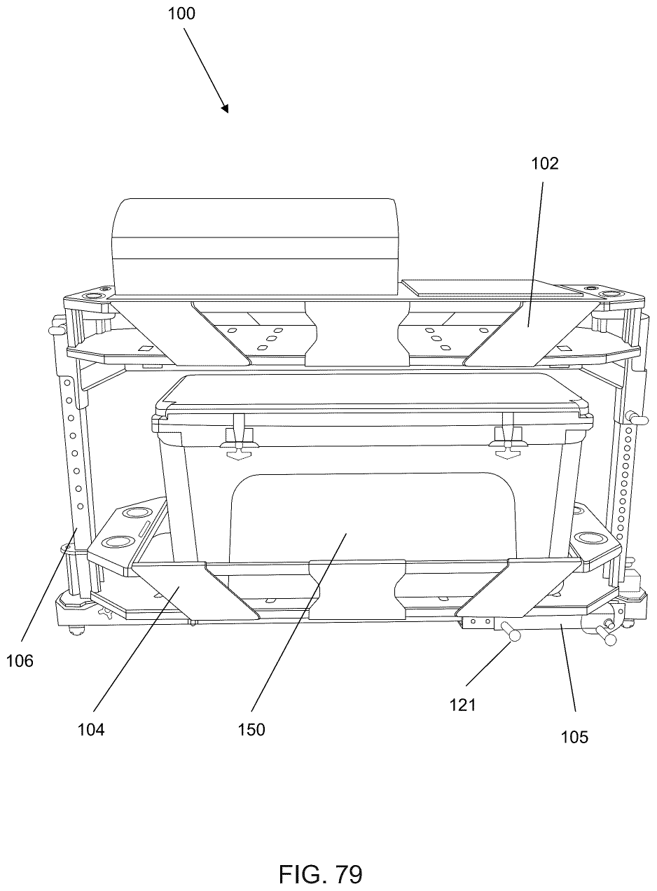

FIGS. 63-66, 69, 74 illustrate components of the hitch rack 100 of the present disclosure. Lower rack 104 is shown secured to support leg 105 and upper carrier stabilizer 106, and hinge 114, all of which in turn are mounted to main frame 110. Pins 121 allow for the selectable movement (e.g., rotation) of those components when activated by the user. Height adjustment device 118 may be positioned by the user to raise or lower upper rack 102, for example. FIGS. 67-68, 70-73 , and 75-79 illustrate additional configurations of the modules of the hitch rack 100.

### Swing-Arm Cargo Platform Embodiment

In embodiments, upper rack 102 and upper stabilizer 106 are coupled to main frame 110 and hinge 114. Hinge 114 allows a user to swing upper rack 102 and upper stabilizer 106 from a closed position adjacent to tailgate T of vehicle V (for example) to one or more deployed positions. Stops included in hinge 114 and selectively secured by pin 121 lock the upper rack 102 and upper stabilizer 106 in a desired position. Returning the configuration to the original state is the reverse process. The pin(s) 121 are configured to secure upper rack 102, upper stabilizer 106 (as well as other modular components described herein) for travel, storage, parking, etc.

### Trays, Perimeter Guards, and Tie-Down Matrix

Each upper rack 102 and lower rack 104 forms a tray that includes a perforated deck 107 bordered by side rails 112 forming a perimeter guard. The perforated deck 107 presents a tie-down matrix with holes and/or slots to receive straps or modular brackets in some embodiments. The matrix enables orthogonal and diagonal strap vectors to restrain shifting payloads such as coolers 150 and/or totes 194.

### Structure and Fastening

Cross members and gussets couple the racks 102, 104 to the swing-arm 106 and resist torsion with cargo applied. Fasteners can include carriage bolts through countersunk perforations of the deck 107 with nuts and washers accessible from the underside. The hinge 114 can incorporate a removable hinge pin 121 for service or arm replacement.

### Stabilizer Post and Field Use

A support leg 105 is optionally extendable to contact the ground when the swing-arm 106 is deployed. In some embodiments, the support leg 105 functions as a stabilizer post that telescopes between a stowed length and an extended length and includes a locking collar, detent, or jack mechanism to hold the leg at a selected height. A ground-engaging foot on the stabilizer post can include a high-friction pad or enlarged surface to resist sliding and to distribute load on pavement, soil, or other terrain.

When deployed under the swing-arm 106, the stabilizer post supports at least a portion of the combined weight of trays 102, 104 and their payloads, such as a cooler payload 150 and a tote payload 194. This load sharing reduces the bending moment and vertical deflection at hinge 114 and at the hitch-mounted pivot mast 110 that would otherwise occur due to the lever arm between the trays and the vehicle hitch. In some embodiments, the stabilizer post incorporates a jack screw, cam jack, or ratcheting jack that applies a slight upward pre-load into the swing-arm 106 so that the trays remain substantially level under load and the assembly achieves a higher practical payload capacity than comparable swing-away racks that do not employ a ground-contacting stabilizer.

### Method of Deployment and Loading

In one embodiment the method is as follows: (i) unlatch the locking pin 121; (ii) rotate the upper rack 102, lower rack 104, grill G, etc. to a selected deployed position where a position stop to receive pin 121 provides retention; (iii) if provided, extend the support leg 105 to the ground; (iv) place the payload on one or both racks 102, 104; (v) route straps through the decks 107 of racks 102, 104 to secure the payload; and (vi) retract support leg 105 (optionally deployed), rotate the racks 102, 104 to the closed position, and re-engage the pin 121 for travel. In some methods, the user extends and locks the stabilizer post to the ground before loading heavier payloads so that the stabilizer carries a portion of the load during both deployment and travel.

### Compatibility and Modularity

The hitch rack 100 accepts interchangeable accessory modules that mount to the perforated deck 107 using its tie-down matrix, including storage bins 194, cooking surfaces G, winch or crane attachments 130-136, bike mounts 160, and work surfaces 180. Accessories may be installed at either rack 102, 104 to balance loads and to maintain rear-vehicle access for a given deployment angle.

### Exemplary Manufacturing and Variations

Components can be laser-cut and press-braked with weldments at high-stress junctions, or extrusions and castings where appropriate. Surface finishes may include powder coat or anodize. Drainage apertures can be integrated into the perforated deck 107. Variants include detents or cams providing tactile feedback at intermediate angles, integrated reflectors or lighting, lockable latch hardware, and quick-swap hardware for accessories.

The foregoing detailed description describes various embodiments of a racked modular system, interchangeable modules, and a vehicle hitch mounted cargo platform with a stabilizer post. These embodiments are not intended to be exhaustive or to limit the invention to the precise forms disclosed. Rather, the described embodiments are chosen and described to best explain the principles of the invention and its practical applications so that others skilled in the art may enable and modify the invention as suited to particular uses.

Unless otherwise expressly stated, features described in connection with any embodiment may be used alone or in combination with features of any other embodiment. Individual elements may be omitted, substituted, or added without departing from the scope of the invention as defined by the appended claims. The scope of the invention is, therefore, indicated by the appended claims rather than by the foregoing description, and all changes that come within the meaning and range of equivalency of the claims are intended to be embraced therein.

As used in the claims, the terms comprising, including, and having are intended to be open ended and non-exclusive. Functional language is intended to describe the capabilities of the structures and methods and is not intended to invoke 35 U.S.C. § 112(f) unless the term means for or step for is expressly used in connection with a recited function without recitation of corresponding structure, material, or acts.

1. A racked modular system comprising:
a rack frame defining a bay;
a module sized to be received in the bay and removably mounted to the rack frame at a seated position;
a locating interface between the module and the rack frame configured to constrain at least pitch and yaw when the module is seated;
a quick-release latch coupled to the module and arranged to draw the module into the seated position against the rack frame; and
a backplane at a rear of the bay including a blind-mate electrical connector aligned to mate with a corresponding connector of the module as the module reaches the seated position.

2. The system of claim 1, wherein the rack frame includes opposing guide rails that define the bay and the module is configured to slide along the guide rails into the bay.

3. The system of claim 1, wherein the locating interface comprises a tapered pin and a complementary tapered bore.

4. The system of claim 1, wherein the quick-release latch includes an over-center cam configured to apply a seating force without tools.

5. The system of claim 1, further comprising an ejection lever coupled to the quick-release latch to initiate module extraction when the latch is released.

6. The system of claim 1, wherein the backplane includes a floating mount for the blind-mate electrical connector to accommodate tolerance variation.

7. The system of claim 1, further comprising a latch sensor configured to detect whether the quick-release latch is in a latched state.

8. A module configured for installation in a racked modular system having a rack frame that defines a bay, the module comprising:
a chassis sized to be received in the bay;
an alignment interface configured to cooperate with a complementary interface of the rack frame to constrain at least pitch and yaw at a seated position;
a connector mounted to the chassis and configured for blind-mating with a backplane connector at the seated position; and
a quick-release latch having an over-center cam to draw the module to the seated position relative to the rack frame.

9. The module of claim 8, wherein the chassis is configured to slide along guide rails of the rack frame into the bay.

10. The module of claim 8, further comprising a vibration isolation mount positioned between the chassis and the guide rails.

11. The module of claim 8, wherein the quick-release latch further comprises an ejection lever configured to apply an initial extraction force when the module is unlatched.

12. The module of claim 8, wherein the connector is mounted to float within limited travel to accommodate tolerance variation during blind-mating.

13. The module of claim 8, further comprising an airflow shroud configured to direct cooling air across the chassis when the module is seated.

14. A cargo platform assembly comprising:
a pivot mast configured for attachment to a vehicle;
a swing-arm coupled to the pivot mast for movement between a closed position adjacent the vehicle and at least one deployed position;
first and second trays carried by the swing-arm, each tray including a perforated deck and side rails that define a perimeter guard;
a latch configured to retain the swing-arm in the closed position; and
an accessory hole matrix arranged to receive tie-downs or modular brackets.

15. The assembly of claim 14, wherein the deployed positions include a half-open position and a fully-open position defined by stops at the pivot mast.

16. The assembly of claim 14, further comprising a stabilizer post configured to contact the ground when the swing-arm is deployed to reduce deflection under load.

17. The assembly of claim 16, wherein the stabilizer post is telescoping between a stowed length and an extended length and includes a locking collar or detent mechanism configured to hold the stabilizer post at selected heights.

18. The assembly of claim 14, wherein the swing-arm extends across the pivot mast such that the first tray is located on a first side of the pivot mast and the second tray is located on an opposite side of the pivot mast so that payloads supported by the trays are distributed on opposite sides of the pivot mast.

19. The assembly of claim 16, wherein the stabilizer post comprises a jack mechanism selected from a threaded jack screw, a cam jack, and a ratcheting jack, configured to apply an upward pre-load to the swing-arm to counteract deflection induced by cargo weight.

20. The assembly of claim 14, wherein the pivot mast is coupled to a hitch receiver via a receiver insert and a pivot axis of the swing-arm is offset laterally relative to the receiver insert such that in the closed position the trays are positioned closer together to reduce an overall width of the assembly and in a deployed position the trays are spaced farther apart to increase usable width and clearance relative to a rear portion of the vehicle.
